(19) United States
(12) Patent Application Publication
(10) Pub. No.: US 2026/0291792 A1
(43) Pub. Date: Sep. 24, 2026

(54) PHYSICAL LAYER PROTOCOL DATA UNIT FORMATS FOR 60GHZ COMMUNICATIONS

(71) Applicant: QUALCOMM Incorporated, San Diego, CA (US)

(72) Inventors: Lin YANG, San Diego, CA (US); Bin TIAN, San Diego, CA (US); Tzu-Hsuan CHOU, San Diego, CA (US); Youhan KIM, Saratoga, CA (US); Jialing Li CHEN, San Diego, CA (US)

(21) Appl. No.: 19/237,997

(22) Filed: Jun. 13, 2025

Related U.S. Application Data
(63) Continuation-in-part of application No. 19/088,747, filed on Mar. 24, 2025.

(51) Int. Cl. H04L 27/26; H04B 7/06

(52) U.S. Cl. CPC H04L 27/2603; H04B 7/0617; H04B 7/06958

(57) ABSTRACT

This disclosure provides methods, components, devices and systems for physical layer protocol data unit (PPDU) formats for 60 GHz communications. Some aspects more specifically relate to PPDU designs that include a preamble portion that can carry information for decoding of information in a payload portion of a data PPDU in 60 GHz communications. The preamble portion may include a short training field, a long training field, and at least one signal field that includes one or more 60 GHz parameters related to decoding of the data portion. The PPDU may have a frame structure that is upclocked from a PPDU frame structure associated with communications on one or more lower frequency bands. In some aspects, the preamble portion includes at least one signal field includes an integrated millimeter wave (IMMW) signal field that is associated with 60 GHz communications that is jointly encoded with one or more parameters.

### CROSS REFERENCE

The present application for patent is a continuation-in-part of U.S. patent application Ser. No. 19/088,747 by YANG et al., entitled “PHYSICAL LAYER PROTOCOL DATA UNIT FORMATS FOR 60 GHZ COMMUNICATIONS,” filed Mar. 24, 2025, assigned to the assignee hereof, and is expressly incorporated by reference in its entirety herein.

### TECHNICAL FIELD

This disclosure relates generally to wireless communication and, more specifically, to physical layer protocol data unit (PPDU) formats and structures for 60 GHz communications.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a wireless station (STA). The method may include receiving, via at least a portion of a wireless channel associated with 60 GHz communications, a physical layer protocol data unit (PPDU) including a preamble portion, a data portion, and one or more packet extension or training fields, the preamble portion including a short training field, a long training field, and at least one signal field that includes one or more 60 GHz parameters related to decoding of the data portion and decoding the data portion in accordance with the one or more 60 GHz parameters.

Another innovative aspect of the subject matter described in this disclosure can be implemented in a wireless STA apparatus. The wireless STA may include a processing system that includes processor circuitry and memory circuitry that stores code. The processing system may be configured to cause the wireless STA to receive, via at least a portion of a wireless channel associated with 60 GHz communications, a PPDU including a preamble portion, a data portion, and one or more packet extension or training fields, the preamble portion including a short training field, a long training field, and at least one signal field that includes one or more 60 GHz parameters related to decoding of the data portion and decode the data portion in accordance with the one or more 60 GHz parameters.

Another innovative aspect of the subject matter described in this disclosure can be implemented in a wireless STA apparatus. The wireless STA may include means for receiving, via at least a portion of a wireless channel associated with 60 GHz communications, a PPDU including a preamble portion, a data portion, and one or more packet extension or training fields, the preamble portion including a short training field, a long training field, and at least one signal field that includes one or more 60 GHz parameters related to decoding of the data portion and means for decoding the data portion in accordance with the one or more 60 GHz parameters.

Another innovative aspect of the subject matter described in this disclosure can be implemented in a non-transitory computer-readable medium storing code for wireless communications. The code may include instructions executable by one or more processors to receive, via at least a portion of a wireless channel associated with 60 GHz communications, a PPDU including a preamble portion, a data portion, and one or more packet extension or training fields, the preamble portion including a short training field, a long training field, and at least one signal field that includes one or more 60 GHz parameters related to decoding of the data portion and decode the data portion in accordance with the one or more 60 GHz parameters.

In some examples of the method, STAs, and non-transitory computer-readable medium described herein, the PPDU may have a frame structure that is upclocked from a PPDU frame structure associated with communications on one or more frequency bands that is lower than 60 GHz communications frequency bands. In some examples of the method, STAs, and non-transitory computer-readable medium described herein, the preamble portion of the PPDU is upclocked at a smaller ratio than the data portion of the PPDU, and provides that one or more legacy fields of the preamble portion have a same tone spacing and symbol duration as the data portion. In some examples of the method, STAs, and non-transitory computer-readable medium described herein, the preamble portion of the PPDU spans multiple sub-bands of a bandwidth of the wireless channel, and the short training field, the long training field, and the at least one signal field may be duplicated across multiple sub-bands, and the data portion spans all of the sub-bands of the bandwidth of the wireless channel.

In some examples of the method, STAs, and non-transitory computer-readable medium described herein, at least the short training field, the long training field, and at least one signal field of the preamble portion may be upclocked from corresponding fields of a PPDU frame structure associated with communications on one or more frequency bands that are lower than 60 GHz communications frequency bands, and the at least one signal field includes an integrated millimeter wave (IMMW) signal field that us associated with 60 GHz communications. In some examples of the method, STAs, and non-transitory computer-readable medium described herein, the IMMW signal field includes legacy signal field information that is jointly encoded with one or more parameters associated with 60 GHz communications. In some examples of the method, STAs, and non-transitory computer-readable medium described herein, the IMMW signal field includes one or more version independent fields that are independent of a protocol version associated with the PPDU and one or more version dependent fields in accordance with the protocol version associated with the PPDU, and where the one or more version independent fields and the one or more version dependent fields are jointly encoded or are separately encoded.

In some examples of the method, STAs, and non-transitory computer-readable medium described herein, the preamble portion includes one or more legacy fields that are transmitted via a first portion of a channel bandwidth of the wireless channel and one or more non-legacy fields of the preamble portion, and the data portion, are transmitted using a second portion of the channel bandwidth that are larger than the first portion of the channel bandwidth, where the first portion is a subset or a sub-band of the second portion.

Another innovative aspect of the subject matter described in this disclosure can be implemented in a method for wireless communications by a wireless access point (AP). The method may include encoding a data portion of a PPDU in accordance with one or more 60 GHz parameters associated with 60 GHz communications and transmitting, via at least a portion of a wireless channel associated with 60 GHz communications, the PPDU to at least one STA, the PPDU including a preamble portion, the data portion, and one or more packet extension or training fields, the preamble portion including a short training field, a long training field, and at least one signal field that indicates the one or more 60 GHz parameters for decoding of the data portion.

Another innovative aspect of the subject matter described in this disclosure can be implemented in a wireless AP. The wireless AP may include a processing system that includes processor circuitry and memory circuitry that stores code. The processing system may be configured to cause the wireless AP to encode a data portion of a PPDU in accordance with one or more 60 GHz parameters associated with 60 GHz communications and transmit, via at least a portion of a wireless channel associated with 60 GHz communications, the PPDU to at least one STA, the PPDU including a preamble portion, the data portion, and one or more packet extension or training fields, the preamble portion including a short training field, a long training field, and at least one signal field that indicates the one or more 60 GHz parameters for decoding of the data portion.

Another innovative aspect of the subject matter described in this disclosure can be implemented in a wireless AP. The wireless AP may include means for encoding a data portion of a PPDU in accordance with one or more 60 GHz parameters associated with 60 GHz communications and means for transmitting, via at least a portion of a wireless channel associated with 60 GHz communications, the PPDU to at least one STA, the PPDU including a preamble portion, the data portion, and one or more packet extension or training fields, the preamble portion including a short training field, a long training field, and at least one signal field that indicates the one or more 60 GHz parameters for decoding of the data portion.

Another innovative aspect of the subject matter described in this disclosure can be implemented in a non-transitory computer-readable medium storing code for wireless communications. The code may include instructions executable by one or more processors to encode a data portion of a PPDU in accordance with one or more 60 GHz parameters associated with 60 GHz communications and transmit, via at least a portion of a wireless channel associated with 60 GHz communications, the PPDU to at least one STA, the PPDU including a preamble portion, the data portion, and one or more packet extension or training fields, the preamble portion including a short training field, a long training field, and at least one signal field that indicates the one or more 60 GHz parameters for decoding of the data portion.

In some examples of the method, APs, and non-transitory computer-readable medium described herein, the PPDU may have a frame structure that is upclocked from a PPDU frame structure associated with communications on one or more frequency bands that are lower than 60 GHz communications frequency bands. In some examples of the method, APs, and non-transitory computer-readable medium described herein, the preamble portion of the PPDU is upclocked at a smaller ratio than the data portion of the PPDU, and provides that one or more legacy fields of the preamble portion have a same tone spacing and symbol duration as the data portion. In some examples of the method, APs, and non-transitory computer-readable medium described herein, the preamble portion of the PPDU spans multiple sub-bands of a bandwidth of the wireless channel, and the short training field, the long training field, and the at least one signal field is duplicated across multiple sub-bands, and the data portion spans all of the sub-bands of the bandwidth of the wireless channel.

In some examples of the method, APs, and non-transitory computer-readable medium described herein, at least the short training field, the long training field, and at least one signal field of the preamble portion is upclocked from corresponding fields of a PPDU frame structure associated with communications on one or more frequency bands that are lower than 60 GHz communications frequency bands, and the at least one signal field includes an integrated millimeter wave (IMMW) signal field that is associated with 60 GHz communications.

In some examples of the method, APs, and non-transitory computer-readable medium described herein, the IMMW signal field includes legacy signal field information that is jointly encoded with one or more parameters associated with 60 GHz communications. In some examples of the method, APs, and non-transitory computer-readable medium described herein, the IMMW signal field includes one or more version independent fields that are independent of a protocol version associated with the PPDU and one or more version dependent fields in accordance with the protocol version associated with the PPDU, and where the one or more version independent fields and the one or more version dependent fields are jointly encoded or are separately encoded.

In some examples of the method, APs, and non-transitory computer-readable medium described herein, the preamble portion includes a legacy short training field (L-STF) and a legacy long training field (L-LTF) that may be duplicated in each sub-band of a set of multiple sub-bands of a channel bandwidth of the wireless channel and the one or more signal fields may be duplicated in one or more smallest schedulable bandwidth blocks that each span two or more sub-bands of the set of multiple sub-bands.

Another innovative aspect of the subject matter described in this disclosure can be implemented in a method for wireless communications by a wireless device, such as a STA or an AP. The method may include receiving, via at least a portion of a wireless channel associated with 60 GHz communications, a PPDU including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion and decoding the data portion in accordance with the one or more 60 GHz parameters.

Another innovative aspect of the subject matter described in this disclosure can be implemented in a wireless device, such as a STP or an AP. The wireless device may include a processing system that includes processor circuitry and memory circuitry that stores code. The processing system may be configured to cause the wireless device to receive, via at least a portion of a wireless channel associated with 60 GHz communications, a PPDU including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion and decode the data portion in accordance with the one or more 60 GHz parameters

Another innovative aspect of the subject matter described in this disclosure can be implemented in a wireless device, such as a STA or an AP. The wireless device may include means for receiving, via at least a portion of a wireless channel associated with 60 GHz communications, a PPDU including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion and means for decoding the data portion in accordance with the one or more 60 GHz parameters.

Another innovative aspect of the subject matter described in this disclosure can be implemented in a non-transitory computer-readable medium storing code for wireless communications. The code may include instructions executable by one or more processors to receive, via at least a portion of a wireless channel associated with 60 GHz communications, a PPDU including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion and decode the data portion in accordance with the one or more 60 GHz parameters.

In some examples of the method, wireless devices, and non-transitory computer-readable medium described herein, the legacy preamble portion spans all sub-bands of the bandwidth of the wireless channel. In some examples of the method, wireless devices, and non-transitory computer-readable medium described herein, a first instance of the legacy preamble portion spans a first subset of sub-bands of the bandwidth of the wireless channel, and a second duplicated instance of the legacy preamble portion spans a second subset of sub-bands of the bandwidth of the wireless channel. In some examples of the method, wireless devices, and non-transitory computer-readable medium described herein, two or more instances of the legacy preamble portion may be duplicated in time on the one or more sub-bands of the bandwidth of the wireless channel.

In some examples of the method, wireless devices, and non-transitory computer-readable medium described herein, the at least one signal field includes an IMMW signal field that is associated with 60 GHz communications. In some examples of the method, wireless devices, and non-transitory computer-readable medium described herein, the IMMW signal field includes a common portion, and one or more of a data demodulation portion, a beam refinement parameter (BRP) portion, or a sector sweep (SSW) portion. In some examples of the method, wireless devices, and non-transitory computer-readable medium described herein, the common portion of the IMMW signal field may be separately encoded from other portions of the IMMW signal field.

Another innovative aspect of the subject matter described in this disclosure can be implemented in a method for wireless communications by a wireless device, such as a STA or an AP. The method may include receiving, via at least a portion of a wireless channel associated with 60 GHz communications, one or more first PPDUs having a first format for beam selection, selecting a first beam for communications based on the one or more first PPDUs, and receiving, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

Another innovative aspect of the subject matter described in this disclosure can be implemented in a wireless device, such as a STP or an AP. The wireless device may include a processing system that includes processor circuitry and memory circuitry that stores code. The processing system may be configured to cause the wireless device to receive, via at least a portion of a wireless channel associated with 60 GHz communications, one or more first PPDUs having a first format for beam selection, select a first beam for communications based on the one or more first PPDUs, and receive, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

Another innovative aspect of the subject matter described in this disclosure can be implemented in a wireless device, such as a STA or an AP. The wireless device may include means for receiving, via at least a portion of a wireless channel associated with 60 GHz communications, one or more first PPDUs having a first format for beam selection, means for selecting a first beam for communications based on the one or more first PPDUs, and means for receiving, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

Another innovative aspect of the subject matter described in this disclosure can be implemented in a non-transitory computer-readable medium storing code for wireless communications. The code may include instructions executable by one or more processors to receive, via at least a portion of a wireless channel associated with 60 GHz communications, one or more first PPDUs having a first format for beam selection, select a first beam for communications based on the one or more first PPDUs, and receive, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

In some examples of the method, wireless devices, and non-transitory computer-readable medium described herein, the one or more first PPDUs are SSW PPDUs that are transmitted using different beams, and where the SSW PPDUs may be NDP PPDUs. In some examples of the method, wireless devices, and non-transitory computer-readable medium described herein, the second PPDU is a BRP PPDU that may be transmitted with or without an associated data portion.

Another innovative aspect of the subject matter described in this disclosure can be implemented in a method for wireless communications by a wireless device, such as a STA or an AP. The method may include encoding a data portion of a PPDU in accordance with one or more 60 GHz parameters associated with 60 GHz communications and transmitting, via at least a portion of a wireless channel associated with 60 GHz communications, the PPDU to at least one other wireless device, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion.

Another innovative aspect of the subject matter described in this disclosure can be implemented in a wireless device, such as a STP or an AP. The wireless device may include a processing system that includes processor circuitry and memory circuitry that stores code. The processing system may be configured to cause the wireless device to encode a data portion of a PPDU in accordance with one or more 60 GHz parameters associated with 60 GHz communications and transmit, via at least a portion of a wireless channel associated with 60 GHz communications, the PPDU to at least one other wireless device, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion.

Another innovative aspect of the subject matter described in this disclosure can be implemented in a wireless device, such as a STA or an AP. The wireless device may include means for encoding a data portion of a PPDU in accordance with one or more 60 GHz parameters associated with 60 GHz communications and means for transmitting, via at least a portion of a wireless channel associated with 60 GHz communications, the PPDU to at least one other wireless device, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion.

Another innovative aspect of the subject matter described in this disclosure can be implemented in a non-transitory computer-readable medium storing code for wireless communications. The code may include instructions executable by one or more processors to encode a data portion of a PPDU in accordance with one or more 60 GHz parameters associated with 60 GHz communications and transmit, via at least a portion of a wireless channel associated with 60 GHz communications, the PPDU to at least one other wireless device, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion.

In some examples of the method, wireless devices, and non-transitory computer-readable medium described herein, the legacy preamble portion spans all sub-bands of the bandwidth of the wireless channel. In some examples of the method, wireless devices, and non-transitory computer-readable medium described herein, two or more instances of the legacy preamble portion may be duplicated in time on the one or more sub-bands of the bandwidth of the wireless channel. In some examples of the method, wireless devices, and non-transitory computer-readable medium described herein, the one or more sub-bands include sub-bands each may have a bandwidth associated with a base bandwidth mode or smallest bandwidth allowed in an IMMW 60 GHz communications system. In some examples of the method, wireless devices, and non-transitory computer-readable medium described herein, a common portion of the IMMW signal field may be separately encoded from other portions of the IMMW signal field.

Another innovative aspect of the subject matter described in this disclosure can be implemented in a method for wireless communications by a wireless device, such as a STA or an AP. The method may include transmitting, via at least a portion of a wireless channel associated with 60 GHz communications, one or more first PPDUs having a first format for beam selection and transmitting, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

Another innovative aspect of the subject matter described in this disclosure can be implemented in a wireless device, such as a STP or an AP. The wireless device may include a processing system that includes processor circuitry and memory circuitry that stores code. The processing system may be configured to cause the wireless device to transmit, via at least a portion of a wireless channel associated with 60 GHz communications, one or more first PPDUs having a first format for beam selection and transmit, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

Another innovative aspect of the subject matter described in this disclosure can be implemented in a wireless device, such as a STA or an AP. The wireless device may include means for transmitting, via at least a portion of a wireless channel associated with 60 GHz communications, one or more first PPDUs having a first format for beam selection and means for transmitting, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

Another innovative aspect of the subject matter described in this disclosure can be implemented in a non-transitory computer-readable medium storing code for wireless communications. The code may include instructions executable by one or more processors to transmit, via at least a portion of a wireless channel associated with 60 GHz communications, one or more first PPDUs having a first format for beam selection and transmit, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

In some examples of the method, wireless devices, and non-transitory computer-readable medium described herein, the one or more first PPDUs are SSW PPDUs that are transmitted using different beams, and where the SSW PPDUs may be NDP PPDUs. In some examples of the method, wireless devices, and non-transitory computer-readable medium described herein, the second PPDU is a BRP PPDU that may be transmitted with or without an associated data portion.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIGS. 4A and 4B show examples of PPDU formats that support physical layer protocol data unit formats for 60 GHz communications.

FIG. 5 shows an example of a PPDU format with integrated millimeter wave (IMMW) signal fields that supports physical layer protocol data unit formats for 60 GHz communications.

FIGS. 6A and 6B show examples of PPDU formats with IMMW signal fields that support physical layer protocol data unit formats for 60 GHz communications.

FIG. 7 shows an example of a PPDU format with preamble portion fields that occupy different bandwidths that supports physical layer protocol data unit formats for 60 GHz communications.

FIG. 8 shows an example of a PPDU format that supports physical layer protocol data unit formats for 60 GHz communications.

FIG. 9 shows an example of a PPDU format that supports physical layer protocol data unit formats for 60 GHz communications.

FIG. 10 shows an example of a PPDU format with a buffer symbol that supports physical layer protocol data unit formats for 60 GHz communications.

FIG. 11 shows another example of a PPDU format with preamble portion fields that occupy different bandwidths that supports physical layer protocol data unit formats for 60 GHz communications.

FIG. 12 shows an example of a PPDU format with time domain repetitions of preamble portion fields that supports physical layer protocol data unit formats for 60 GHz communications.

FIG. 13 shows another example of a PPDU format with preamble portion fields that occupy different bandwidths that supports physical layer protocol data unit formats for 60 GHz communications.

FIGS. 14 and 15 show examples of PPDU formats that support beam selection for 60 GHz communications.

FIG. 16 shows a block diagram of an example wireless communication device that supports physical layer protocol data unit formats for 60 GHz communications.

FIG. 17 shows a block diagram of an example wireless communication device that supports physical layer protocol data unit formats for 60 GHz communications.

FIG. 18 shows a flowchart illustrating an example process performable by or at a wireless STA that supports physical layer protocol data unit formats for 60 GHz communications.

FIG. 19 shows a flowchart illustrating an example process performable by or at a wireless AP that supports physical layer protocol data unit formats for 60 GHz communications.

FIGS. 20 through 23 show flowcharts illustrating example processes performable by or at a wireless device that supports physical layer protocol data unit formats for 60 GHz communications.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, physical layer protocol data units (PPDUs) may be used in communications to provide information and data. A data PPDU may include a physical (PHY) layer preamble and a data payload. The information provided in the preamble may be used by a receiving device to decode the subsequent data included in the PPDU. In some cases, a PPDU may be transmitted over wideband channel, and preamble fields may be duplicated and transmitted in each of multiple component channels. The preamble fields may include information associated with a wideband channel that may be used to decode a data portion of the PPDU. Communications protocols using higher frequency bands are being developed, such as communications in frequency bands that span from 57 GHz up to 71 GHz, which may be referred to generally as 60 GHz communications. Existing PPDU formats may not provide information related to 60 GHz communications, or may not have a format that is compatible for efficient decoding of information in 60 GHz communications (among other relatively higher frequency bands).

Various aspects relate generally to PPDU designs associated with 60 GHz communications. Some aspects more specifically relate to data PPDU designs that include a preamble portion that can carry information for decoding of information in a payload portion of the data PPDU in 60 GHz communications. In some examples, the preamble portion may include a short training field, a long training field, and at least one signal field that includes one or more 60 GHz parameters related to decoding of the data portion. In some examples, the PPDU has a frame structure that is upclocked from a PPDU frame structure associated with communications on one or more frequency bands that are lower than 60 GHz communications frequency bands (e.g., a frequency bandwidth of the frame structure may be multiplied by a factor (e.g., 4×, 8×, 16×, or 32×)). In some examples, the preamble portion includes at least one signal field includes an integrated millimeter wave (IMMW) signal field that is associated with 60 GHz communications that is jointly encoded with one or more parameters associated with 60 GHz communications. In some examples, the IMMW signal field may include a common portion, and one or more of a data demodulation portion, a beam refinement parameter (BRP) portion, or a sector sweep (SSW) portion. In some examples, the common portion may be encoded separately from other portions of the IMMW signal field. In some examples, the preamble portion may include one or more fields (e.g., legacy fields) that are duplicated in each sub-band of a set of two or more sub-bands of a channel bandwidth, and one or more non-legacy signal fields span two or more sub-bands of the set of sub-bands. In some examples, the preamble portion may include one or more legacy fields that are transmitted in a subset of bandwidth (e.g., a smallest schedulable bandwidth or a base bandwidth) of the channel bandwidth, and one or more non-legacy fields that may be transmitted in a wider bandwidth than the legacy fields. In some examples, the preamble portion may be transmitted only on the base bandwidth, or may be duplicated in the frequency domain across a wider bandwidth than the base bandwidth in a wide bandwidth mode. In some examples, the preamble portion may include one or more fields (e.g., legacy fields) that are duplicated in the time domain on a base bandwidth or channel bandwidth, and a single instance of one or more non-legacy fields are transmitted on the channel bandwidth. Additionally, or alternatively, beam search and refinement may be performed using PPDU formats that include a first PPDU format for beam selection and a second PPDU format for beam refinement that includes at least one signal field with one or more beam refinement parameters (BRPs).

In some examples, the preamble portion may not include any legacy fields, and a same tone plan and numerology may be used for the preamble portion and the data portion. Additionally, or alternatively, the data portion of the PPDU may include control information associated with wireless communications between the STA and an access point, that may be transmitted in a medium access control (MAC) control frame included in the data portion that uses a subset of bandwidth (e.g., a smallest schedulable channel bandwidth) of the wireless channel. Additionally, or alternatively, the PPDU may be an enhanced long range (ELR) PPDU that includes one or more extensions relative to a non-ELR PPDU, and the PPDU may be transmitted using one or more of power boosting, a lower coding rate, a lower modulation order, or signal repetition, or any combination thereof, relative to a non-ELR PPDU.

Particular aspects of the subject matter described in this disclosure can be implemented to realize one or more of the following potential advantages. In some examples, by providing a PPDU format that is upclocked from a PPDU format associated with lower frequency communications, the described techniques enable PPDU processing using hardware components and processing that is common with the lower frequency communications. In some examples, by providing an IMMW signal field that is jointly encoded with one or more parameters associated with 60 GHz communications, the described techniques may be used to provide efficient decoding and processing of the parameters of the IMMW signal field.//Additionally, or alternatively, by providing an IMMW signal field that includes a common portion that is encoded separately from other portions, decoding of the common portion may be performed separately and parameters related to the PPDU may be identified for subsequent processing of the PPDU. Additionally, or alternatively, by providing one or more signal fields span two or more sub-bands, the described techniques may be used to provide signaling information in a single symbol. In some examples, by providing legacy fields that are transmitted in a subset of bandwidth (e.g., a smallest schedulable bandwidth or base bandwidth) of the channel bandwidth, a transmission power of the legacy fields may be boosted. Additionally, or alternatively, by providing a legacy preamble portion that is duplicated in the frequency or time domain, reliability for the detection of the legacy preamble portion may be enhanced. Additionally, or alternatively, by providing control information in a data portion of the PPDU, one or more beamforming parameters for communications between a STA and AP may be updated. In some examples, by providing an ELR PPDU, reliability of communications between STAs and APs that are relatively far apart may be enhanced. Additionally, or alternatively, by providing different PPDU formats for beam selection and beam refinement, beam selection and refinement complexity may be reduced relative to PPDUs that use one or more training fields for beam selection and refinement.

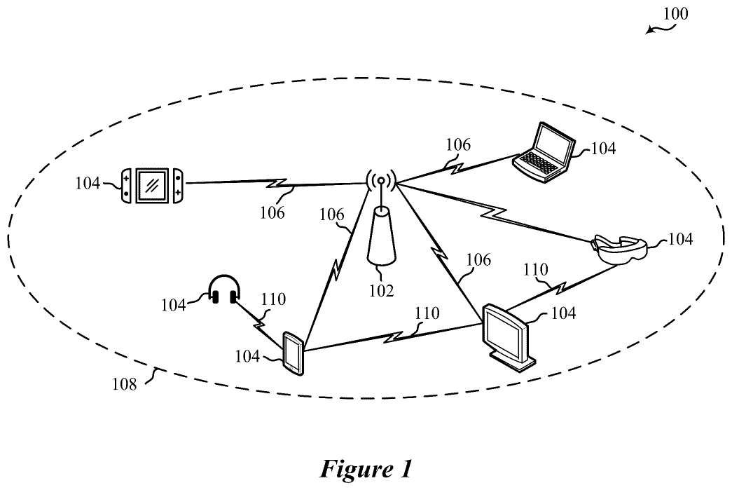

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHZ-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHZ (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

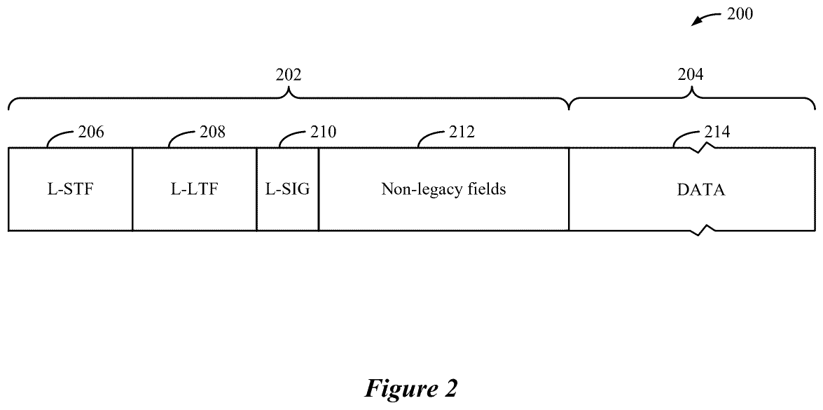

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

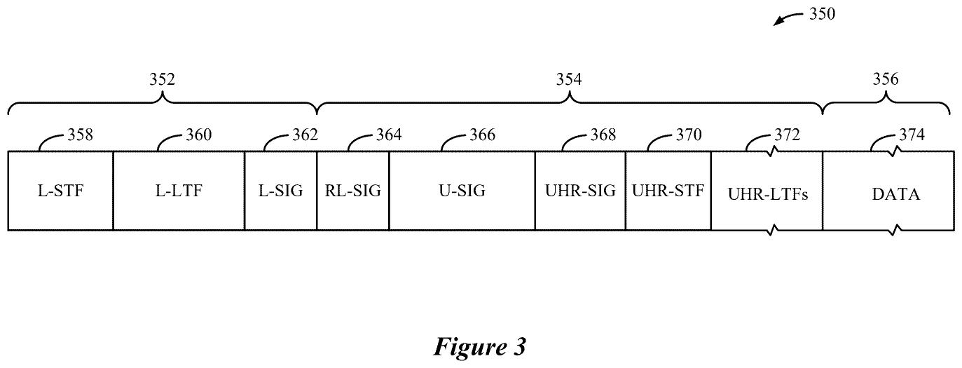

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

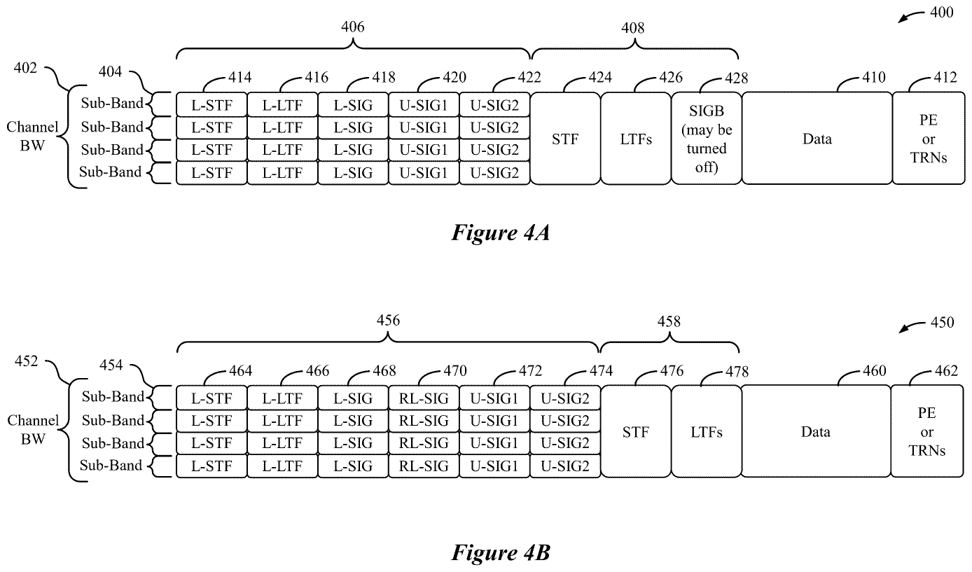

FIGS. 4A and 4B show examples of PPDU formats 400 and 450 that support physical layer protocol data unit formats for 60 GHz communications. In the examples of FIGS. 4A and 4B, PPDU formats 400 and 450 may be upclocked frame structures from PPDUs associated with lower frequency communications. For example, a first PPDU format 400 of FIG. 4A may have a structure that is upclocked from a data PPDU of IEEE 802.11ac that spans 80 MHz to span, for example, a 320 MHz or a 640 MHz channel bandwidth associated with 60 GHz communications (e.g., 4× or 8× upclocking). In a second example, a second PPDU format 450 of FIG. 4B may have a structure that is upclocked from a data PPDU of IEEE 802.11be that spans 20 MHz to span, for example, a 320 MHz or a 640 MHz channel bandwidth associated with 60 GHz communications (e.g., 16× or 32× upclocking).

With reference to FIG. 4A, the first PPDU format 400 shows an example data PPDU usable for communications between a wireless AP and one or more wireless STAs. For example, the AP and STAs may be examples of the AP 102 and the STAs 104 described with reference to FIG. 1. As shown, the first PPDU format 400 may span a channel bandwidth 402 (e.g., a 320 MHz or a 640 MHz channel bandwidth). In this example, the first PPDU format 400 includes a PHY preamble, that includes a legacy portion 406 that is duplicated across multiple sub-bands 404 of the channel bandwidth 402, a non-legacy portion 408, a payload 410 that includes a data field, and one or more packet extension (PE) or training (TRN) fields 412. The legacy portion 406 of the preamble includes an L-STF 414, an L-LTF 416, an L-SIG 418, a first universal signal (U-SIG) field 420, and a second U-SIG field 422. The non-legacy portion 408 of the preamble may span the channel bandwidth 402, and may include a short training field 424 (referred to herein as “STF 424”), one or more long training fields 426 (referred to herein as “LTFs 426”), and an optional SIGB field 428.

With reference to FIG. 4B, the second PPDU format 450 shows an example data PPDU usable for communications between a wireless AP and one or more wireless STAs. For example, the AP and STAs may be examples of the AP 102 and the STAs 104 described with reference to FIG. 1. As shown, the second PPDU format 450 may span a channel bandwidth 452 (e.g., a 320 MHz or a 640 MHz channel bandwidth). In this example, the second PPDU format 450 includes a PHY preamble, that includes a legacy portion 456 that is duplicated across multiple sub-bands 454 of the channel bandwidth 452, a non-legacy portion 458, a payload 460 that includes a data field, and one or more PE or TRN fields 462. The legacy portion 456 of the preamble includes an L-STF 464, an L-LTF 466, an L-SIG 468, a repetition of the L-SIG 468 (referred to herein as “RL-SIG 470”), a first universal signal (U-SIG) field 472, and a second U-SIG field 474. The non-legacy portion 458 of the preamble may span the channel bandwidth 452, and may include a STF 476 and one or more LTFs 478.

As discussed, the first PPDU format 400 and the second PPDU format 450 may correspond to upclocked PPDU structures for communications that use lower frequency bands (e.g., frequency bands that are below 7 GHZ (which may be referred to as “sub-7 communications”). Such upclocked PPDUs may provide that devices may use existing hardware and processing techniques or receive the PPDUs. In some aspects, the upclocking may be based on a bandwidth of sub-bands of the lower frequency bands. For example, an upclocked 802.11be20 data PPDU may be upclocked by, for example, 16× or 32×, and a 4× smaller upclocking ratio may be applied on the legacy portion 456 of the preamble, and the legacy preamble portion 456 may be duplicated by 4× in frequency to span channel bandwidth 452. Thus the resultant legacy portion 456 may have a same tone spacing as payload 460 field, and therefore the different portions may have a same symbol duration and a same per tone power

In some aspects, the SIG fields (e.g., L-SIG+ (RL-SIG)+U-SIG) may include signaling content, and may carry information to support beam refinement and management (about 31 bits) for millimeter wave. Such content may include a PPDU type (regular or BRP-Rx/Tx, 2 bits), training direction (Tx/Rx, 1 bit), beam tracking request (1 bit), training length (5 bits), best antenna ID (2 bits), best sector (6 bits), number of Rx antennas (6 bits), and SNR report (8 bits). Further, in some aspects the SIG fields may carry information for demodulation (about 36 bits), including a bandwidth indication (2 bits), a length (10/12 bits), MCS (5 bits), a number of spatial streams (Nss) (2 bits), a BSS color (6 bits), padding (2 bits), PE ambiguity (1 bits), LDPC extra symbol (1 bits), 2× LDPC (1 bits), ELR (1 bits), and unequal modulation (UEQM) (3 bits). The SIG fields may also carry a PHY-version-ID, a STA-ID (11 bits) and other U-SIG content (for example, BSS Color, TXOP, downlink/uplink, bandwidth, and the like).

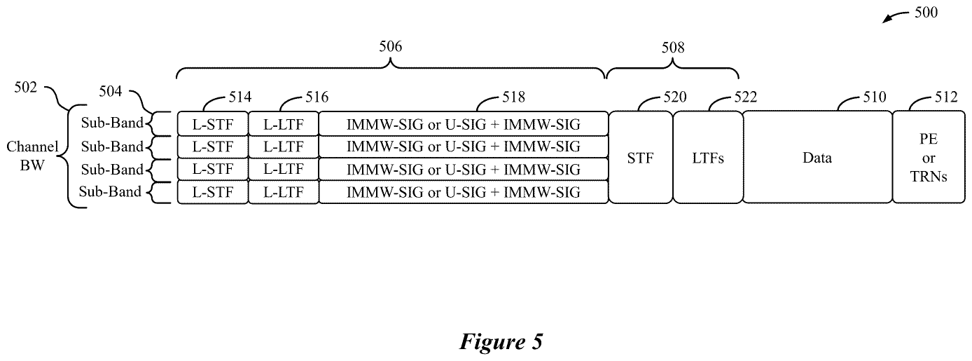

FIG. 5 shows an example of a PPDU format 500 with IMMW signal fields that supports physical layer protocol data unit formats for 60 GHz communications. In the example of FIG. 5, PPDU format 500 may be an upclocked frame structure in which an L-SIG field may be jointly encoded with other SIG fields into an IMMW-SIG field. For example, a PPDU format 500 of FIG. 5 may have a structure that is corresponds to a data PPDU of IEEE 802.11ac or IEEE 802.11be that is upclocked to span, for example, a 320 MHz or a 640 MHz channel bandwidth associated with 60 GHz communications.

The PPDU format 500 shows an example data PPDU usable for communications between a wireless AP and one or more wireless STAs. For example, the AP and STAs may be examples of the AP 102 and the STAs 104 described with reference to FIG. 1. As shown, the PPDU format 500 may span a channel bandwidth 502 (e.g., a 320 MHz or a 640 MHz channel bandwidth). In this example, the PPDU format 500 includes a PHY preamble, that includes a legacy portion 506 that is duplicated across multiple sub-bands 504 of the channel bandwidth 502, a non-legacy portion 508, a payload 510 that includes a data field, and one or more PE or TRN fields 512. The legacy portion 506 of the preamble includes an L-STF 514, an L-LTF 516, and the IMMW-SIG 518 (or a U-SIG+IMMW-SIG) field. The non-legacy portion 508 of the preamble may span the channel bandwidth 502, and may include a STF 520, and one or more LTFs 522.

In some aspects, the IMMW-SIG 518 field may have a SIG encoding structure across time (e.g., where SIG includes L-SIG+(RL-SIG)+U-SIG as discussed with reference to FIG. 4). In some aspects, L-SIG may be jointly encoded with other SIG fields (like U-SIG) in the IMMW-SIG 518 field. In some aspects, the IMMW-SIG 518 field may include one or more version independent fields (e.g., for forward compatibility, including e.g. PHY_version_ID, etc.) and version dependent fields as in U-SIG of sub-7 PPDU formats, which may be re-formatted as U-SIG+IMMW-SIG in some cases. In some aspects, the overall SIG field may carry beam management related signaling, demodulation related parameters, a PHY-version-ID, a STA-ID, and other U-SIG content (for example, BSS Color, TXOP, downlink/uplink, bandwidth, and the like), which may be jointly encoded or separately encoded. In some aspects, version independent field may include a LENGTH field indicating duration of the PPDU. In some aspects, SIG symbol(s) may be binary phase-shift keying (BPSK) or a quadrature BPSK (QBPSK) modulated to indicate different variations or formats.

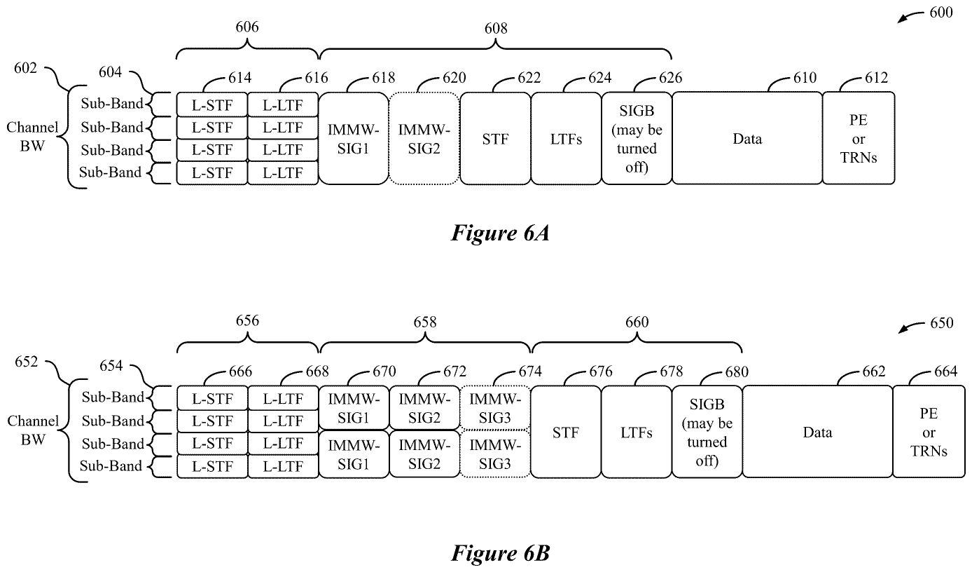

FIGS. 6A and 6B show examples of PPDU formats 600 and 650 with IMMW signal fields that support physical layer protocol data unit formats for 60 GHz communications. In the examples of FIGS. 6A and 6B, PPDU formats 600 and 650 may be upclocked frame structures that correspond to PPDUs associated with lower frequency communications. For example, a first PPDU format 600 of FIG. 6A may have a structure that is upclocked from a data PPDU of IEEE 802.11ac that spans 80 MHz to span, for example, a 320 MHz or a 640 MHz channel bandwidth associated with 60 GHz communications (e.g., 4× or 8× upclocking). In a second example, a second PPDU format 650 of FIG. 6B may have a structure that is upclocked from a data PPDU of IEEE 802.11ac that spans 80 MHz to span, for example, a 320 MHz or a 640 MHz channel bandwidth associated with 60 GHz communications (e.g., 4× or 8× upclocking)

With reference to FIG. 6A, the first PPDU format 600 shows an example data PPDU usable for communications between a wireless AP and one or more wireless STAs. For example, the AP and STAs may be examples of the AP 102 and the STAs 104 described with reference to FIG. 1. As shown, the first PPDU format 600 may span a channel bandwidth 602 (e.g., a 320 MHz or a 640 MHz channel bandwidth). In this example, the first PPDU format 600 includes a PHY preamble, that includes a legacy portion 606 that is duplicated across multiple sub-bands 604 of the channel bandwidth 602, a non-legacy portion 608, a payload 610 that includes a data field, and one or more PE or TRN fields 612. The legacy portion 606 of the preamble includes an L-STF 614 and an L-LTF 616. The non-legacy portion 608 of the preamble may span the channel bandwidth 602, and may include one or more IMMW-SIG fields, for example, an IMMW-SIG1 618 field, an optional IMMW-SIG2 620 field, a STF 622, one or more LTFs 624, and an optional SIGB field 626.

With reference to FIG. 6B, the second PPDU format 650 shows an example data PPDU usable for communications between a wireless AP and one or more wireless STAs. For example, the AP and STAs may be examples of the AP 102 and the STAs 104 described with reference to FIG. 1. As shown, the second PPDU format 650 may span a channel bandwidth 652 (e.g., a 320 MHz or a 640 MHz channel bandwidth). In this example, the second PPDU format 650 includes a PHY preamble, that includes a legacy portion 656 that is duplicated across multiple sub-bands 654 of the channel bandwidth 652, a first non-legacy portion 658, a second non-legacy portion 660, a payload 662 that includes a data field, and one or more PE or TRN fields 664. The legacy portion 656 of the preamble includes an L-STF 666 and an L-LTF 668. The first non-legacy portion 658 includes one or more IMMW-SIG fields, for example, an IMMW-SIG1 670, an IMMW-SIG2 672, and an optional IMMW-SIG3 674 that span multiple sub-bands 654 but less than the full channel bandwidth 652. The second non-legacy portion 660 of the preamble may span the channel bandwidth 652, and may include a STF 676, one or more LTFs 678, and an optional SIGB 680.

In the first PPDU format 600, SIG content spans the channel bandwidth 602 without FD duplication. In some aspects, the SIG symbols may use a 64 point fast Fourier transform (FFT) tone plan with duplication. In some aspects, the SIG symbols may use a same tone plan as data for the given PPDU bandwidth, and the tone plan for L-LTF may be changed to the same tone plan as data as well. In such aspects, one SIG symbol maybe enough to cover all the SIG information, and thus the PPDU may be shorter and consume less overhead. In the second PPDU format 650, SIG content may be FD duplicated, and a base duplication block may correspond to a smallest bandwidth block that is schedulable (e.g., 160 MHz or 320 MHz). In some aspects, the SIG symbols may use a 64 point FFT tone plan with duplication. In some aspects, the SIG symbols may use a same tone plan as a data tone plan with the smallest schedulable bandwidth, and the tone plan for L-LTF may be changed to be the same as the data tone plan with the smallest schedulable bandwidth. Such a second PPDU format 650 may provide that the SIG symbol structure is consistent across different bandwidth modes, although additional SIG symbols may be needed as compared to the first PPDU format 600. In some cases, the IMMW-SIG field(s) can be U-SIG plus IMMW-SIG.

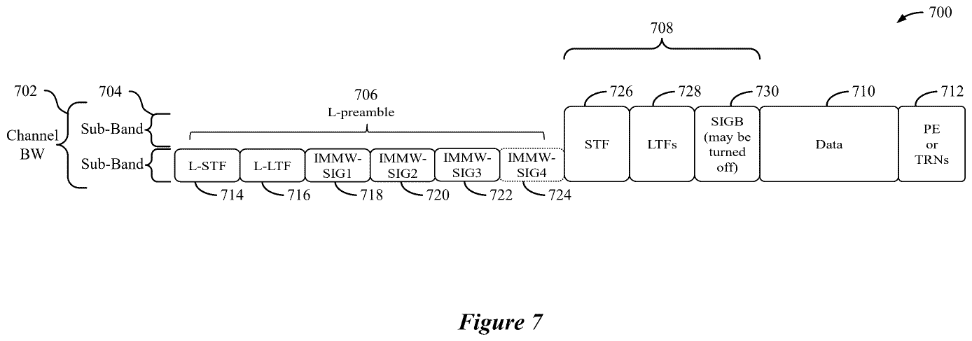

FIG. 7 shows an example of a PPDU format 700 with preamble portion fields that occupy different bandwidths, that supports physical layer protocol data unit formats for 60 GHz communications. In the example of FIG. 7, PPDU format 700 may be an upclocked frame structure in which legacy preamble fields may occupy a different bandwidth than non-legacy fields, and an L-SIG field may be jointly encoded with other SIG fields into an IMMW-SIG field. For example, a PPDU format 700 of FIG. 7 may have a structure that is corresponds to a data PPDU of IEEE 802.11ac or IEEE 802.11be that is upclocked to span, for example, a 320 MHz or a 640 MHz channel bandwidth associated with 60 GHz communications.

The PPDU format 700 shows an example data PPDU usable for communications between a wireless AP and one or more wireless STAs. For example, the AP and STAs may be examples of the AP 102 and the STAs 104 described with reference to FIG. 1. As shown, the PPDU format 700 may span a channel bandwidth 702 (e.g., a 320 MHz or a 640 MHz channel bandwidth). In this example, the PPDU format 700 includes a PHY preamble, that includes a legacy portion 706 that occupies a sub-band 704 of the channel bandwidth 702 without duplication, a non-legacy portion 708, a payload 710 that includes a data field, and one or more PE or TRN fields 712. The legacy portion 706 of the preamble includes an L-STF 714, an L-LTF 716, one or more IMMW-SIG fields, for example, an IMMW-SIG1 718, an IMMW-SIG2 720, an IMMW-SIG3 722, and an optional IMMW-SIG4 724. The non-legacy portion 708 of the preamble may span the channel bandwidth 702, and may include a STF 726, one or more LTFs 728, and an optional SIGB 730.

In some aspects, the legacy portion 706 of the preamble may span one sub-band 704 without FD duplication, without lost link budget gain. In some aspects, this portion of the preamble may be power boosted, if power spectral density (PSD) is not limited. In some aspects, no combining may be needed at a receiver, power may be reduced by focusing on a base block or primary channel (e.g., primary 80 MHz or 160 MHz) only. In some aspects, a different tone plan for data and preamble may be used, and thus separate LTFs and STF may be provided, and additional SIG symbols may be used due to fewer available tones for the preamble.

In some aspects, the legacy portion 706 of the preamble may use a 64-point FFT with same tone spacing as data. This corresponds to a legacy-preamble BW=160 MHz regardless PPDU bandwidth (BW), if SCS=2.5 MHz; or a legacy-preamble BW=80 MHz regardless PPDU BW, if SCS=1.25 MHz. In some aspects, the L-STF length may be extended due to a shot symbol duration. In some aspects, the legacy-preamble may be transmitted over an allowed smallest BW only, regardless PPDU BW. In some aspects, the legacy-preamble uses BW=20 MHz regardless of the PPDU BW, with existing sub-7 GHz preamble numerology (e.g., SCS-312.5 KHz) without upclocking.

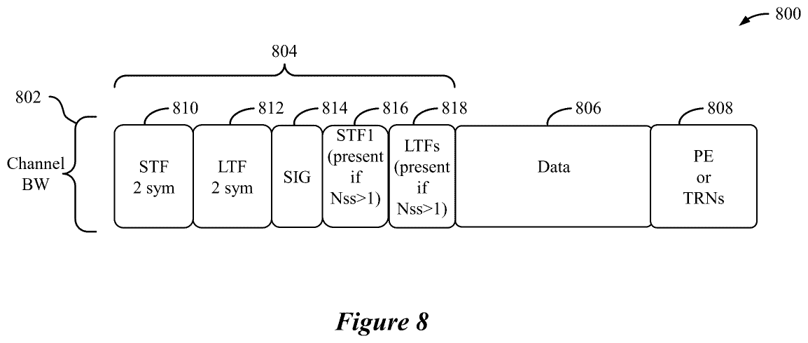

FIG. 8 shows an example of a PPDU format 800 that supports physical layer protocol data unit formats for 60 GHz communications. In the example of FIG. 8, PPDU format 800 may be a green field data PPDU that is not confined by legacy preamble design.

The PPDU format 800 shows an example data PPDU usable for communications between a wireless AP and one or more wireless STAs. For example, the AP and STAs may be examples of the AP 102 and the STAs 104 described with reference to FIG. 1. As shown, the PPDU format 800 may span a channel bandwidth 802 (e.g., a 320 MHz or a 640 MHz channel bandwidth). In this example, the PPDU format 800 includes a PHY preamble 804 that occupies channel bandwidth 802 without duplication, a payload 806 that includes a data field, and one or more PE or TRN fields 808. The PHY preamble 804 includes an STF 810 (e.g., 2~4 symbols), an LTF 812 (e.g., 2 symbols or more with LTF repetition), a SIG 814, an STF1 816 (present if Nss>1), and one or more LTFs 818 (present if Nss>1).

In some aspects, the PPDU format 800 may have a same tone plan and numerology from the PHY preamble 804 to the payload 806 (except the cyclic prefix (CP) can be different). In some aspects, if a 256-point FFT is used, one SIG symbol may be sufficient to carry all signaling information. Further, STF1 816 and LTF1 818 may be skipped when Nss=1, and the CP for data can be reduced.

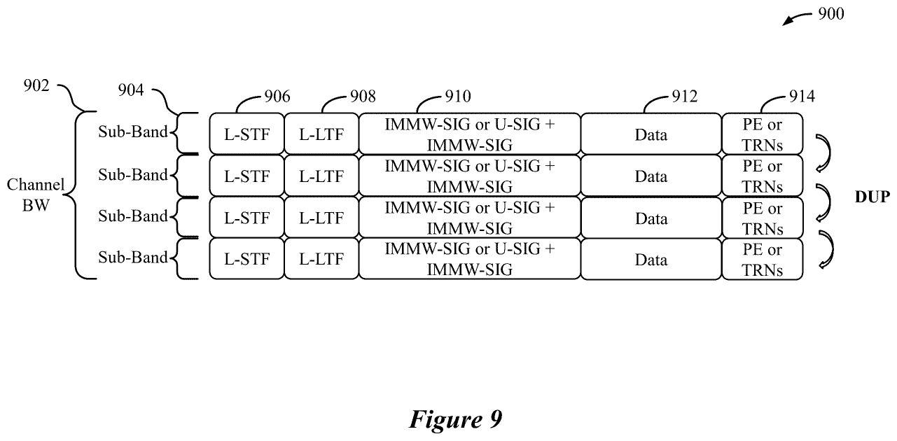

FIG. 9 shows an example of a PPDU format 900 with control information that supports physical layer protocol data unit formats for 60 GHz communications. In the example of FIG. 9, PPDU format 900 may have a format that corresponds to the PPDU format 500 of FIG. 5, with duplication of non-legacy portions of the PPDU, where the payload 912 may include control information (e.g. a medium access control (MAC) control frame).

The PPDU format 900 shows an example of a duplication (DUP) mode of data PPDU usable for communications between a wireless AP and one or more wireless STAs. For example, the AP and STAs may be examples of the AP 102 and the STAs 104 described with reference to FIG. 1. As shown, the PPDU format 900 may span a channel bandwidth 902 (e.g., a 320 MHz or a 640 MHz channel bandwidth). In this example, the PPDU format 900 includes a subband PPDU that is duplicated across multiple sub-bands 904 of the channel bandwidth 902. Specifically, the PPDU format 900 includes a PHY preamble that is duplicated across multiple sub-bands 904 of the channel bandwidth 902, a payload 912 that includes a data field that is duplicated across multiple sub-bands 904, and one or more PE or TRN fields 914 that is duplicated across multiple sub-bands 904. The PHY preamble may include an L-STF 906, an L-LTF 908, and the IMMW-SIG 910 (or a U-SIG+IMMW-SIG) field.

In some aspects, a control frame transmission may be provided in 60 GHz communications, such as in cases where a sub-7 link is not available. In some aspects, a MAC control frame may be transmitted with smallest schedulable BW of the data PPDU, which may boost power and range. In some aspects, if there is base primary channel defined in 60 GHz channels (similar to primary 20 MHz channel in sub-7 GHz), MAC control frames may be transmitted over base primary channel, if not PSD limited, where the base primary channel BW is equal to a smallest schedulable BW of a data PPDU. In some aspects, 60 GHz communications may also have a DUP mode for MAC control frames transmission. In some examples, without control PPDUs, any data PPDU transmission may be directional in both transmission and reception (Tx/Rx), and as such a MAC control frame may not be broadcasted. In some aspects, duplicated PPDUs may be used for devices with different bandwidth capability to be able to decode the control frame (e.g., RTS/CTS/BA/ACK), and may also be provided to comply with MAC rules (e.g., a response frame may have a same BW as a proceeding PPDU).

Additionally, or alternatively, an enhanced long range (ELR) PPDU may be used for 60 GHz communications. In some cases, an ELR PPDU may provide for beam refinement protocol (BRP) training to bridge the gap between an existing beam (or coarse beam) and an enhanced beam (or fine beam for data transmission after BRP). In some aspects, a legacy preamble may be steered with a current beam using an ELR PPDU, and the ELR PPDU may be used to overcome coverage limits that may be caused by a beamforming gain difference between STAs, roughly trained beamforming or an omnidirectional transmission/reception. In some aspects, if no IMMW ELR PPDUs may be provided, a training range may be limited with coarse optimal beam and/or a smallest BW PPDU may be used for beam training. In other aspects, an extension to the basic PPDU format may be used to provide an ELR PPDU, where one or more of power boosting, a lower MCS, or signal repetition may be applied to the basic PPDU format. In some aspects, a certain mode indication (for example, QBPSK modulation on one or more SIG symbols) may be needed to differentiate an ELR PPDU from the basic PPDU format, or the ELR PPDU may be used only at designated mode(s) or period of time(s).

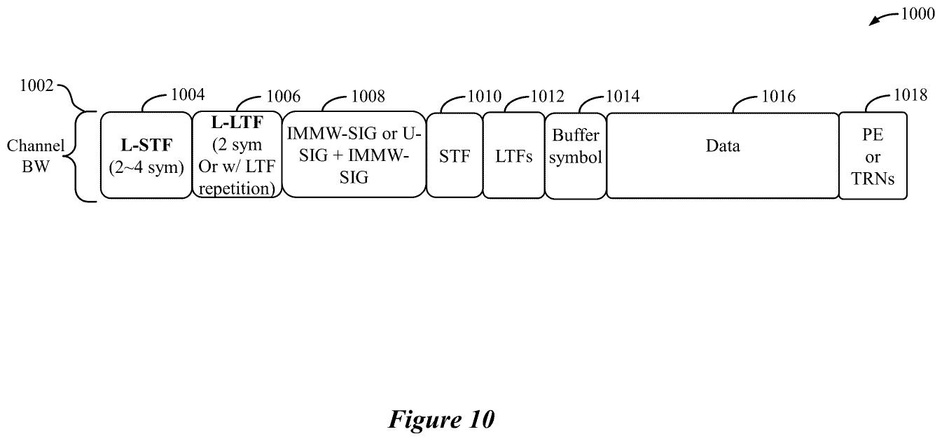

FIG. 10 shows an example of a PPDU format 1000 with a buffer symbol that supports physical layer protocol data unit formats for 60 GHz communications. In the example of FIG. 10, PPDU format 1000 may have a format that corresponds to the PPDU format 500 of FIG. 5, or the PPDU format 600 or 650 of FIG. 6, or the PPDU format 700 of FIG. 7, or the PPDU format 800 of FIG. 8, or the PPDU format 900 of FIG. 9, with an additional buffer symbol 1014 between LTFs 1012 and the payload 1016.

The PPDU format 1000 shows an example data PPDU usable for communications between a wireless AP and one or more wireless STAs. For example, the AP and STAs may be examples of the AP 102 and the STAs 104 described with reference to FIG. 1. As shown, the PPDU format 1000 may span a channel bandwidth 1002 (e.g., a 320 MHz or a 640 MHz channel bandwidth). In this example, the PPDU format 1000 includes a PHY preamble that may include L-STF 1004 (2~4 symbols), L-LTF 1006 (2 symbols or with LTF repetition), IMMW-SIG 1008 (or U-SIG+IMMW-SIG), STF 1010, and LTFs 1012. The PPDU format 1000 may also include a payload 1016 that includes a data field, and one or more PE or TRN fields 1018.

In some aspects, upclocking may shrink the symbol duration proportionally to upclocking ratio, such that a larger upclocking ratio corresponds to a smaller symbol duration. In some cases, processing times may not be scaled with symbol duration, such as for some control loops or automatic gain control (AGC) settling. Thus, preamble processing time may be included in the preamble structure consideration, and in some aspects one or more buffer symbols 1014 may be provided between LTFs 1012 and the payload 1016, in order to allow enough time for a receiver to prepare channel estimation and other demodulation parameters. In some aspects, the one or more buffer symbols 1014 may be dummy symbol(s), or carry anything that is not immediately needed for the following data demodulation (e.g., additional LTF symbols for beam sync up, BRP, interference measurement for future). Further, the SIG symbol structure may be designed to provide enough turn around time for a receive state machine to function properly. In some aspects, there may be a fixed number of SIG symbols between L-LTF 1006 and STF 1010, so the receive state machine knows when to turn on AGC gain setting at the STF symbol(s). In such cases, STF 1010 location may be fixed. In other aspects, if a number of SIG symbols is dynamic, then the signaling of the number of (remaining) SIG symbols may be provided relatively early, so the receive state machine can prepare when to start STF measurement. For example, if SIG=U-SIG+IMMW-SIG, then the number of IMMW-SIG symbols may be signaled in U-SIG. In another example, if SIG=IMMW-SIG, then the number of IMMW-SIG symbols may be signaled in a first symbol of IMMW-SIG 1008. In further aspects, a symbol duration in preamble portion is longer than symbol duration for data portion. For example, the tone spacing of preamble may be smaller than the tone spacing of data.

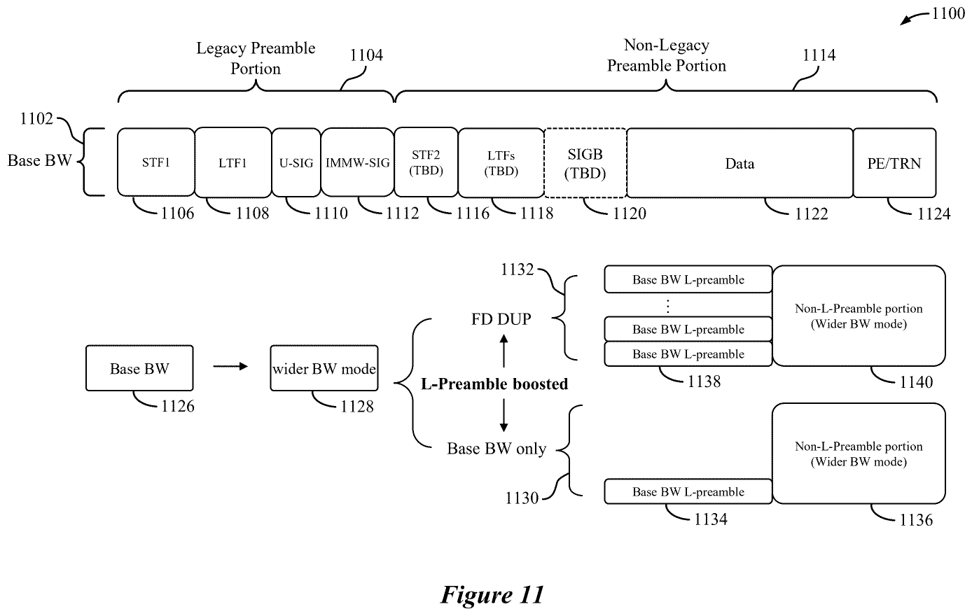

FIG. 11 shows an example of a PPDU format 1100 that supports physical layer protocol data unit formats for 60 GHz communications. In the example of FIG. 11, PPDU format 1100 may be transmitted in a base bandwidth 1102 in a base bandwidth mode (e.g., a smallest bandwidth allowed in an IMMW 60 GHz system, such as 160 MHz or 320 MHz), and in a wider bandwidth (e.g., according to an upclocked frame structure in which legacy preamble fields may occupy a different bandwidth than non-legacy fields) in a wider bandwidth mode.

The PPDU format 1100 shows an example data PPDU usable for communications between a wireless AP and one or more wireless STAs. For example, the AP and STAs may be examples of the AP 102 and the STAs 104 described with reference to FIG. 1. As shown, the PPDU format 1100 may span a base bandwidth 1102 (e.g., a 160 MHz or a 320 MHz base bandwidth) when in a base bandwidth mode, and may span a larger bandwidth (e.g., 320 MHz or 640 MHz) in a wider bandwidth mode. In this example, the PPDU format 1100 includes a PHY preamble, that includes a legacy portion 1104 that occupies a bandwidth corresponding to the base bandwidth 1102 without duplication, and a non-legacy portion 1114. The legacy portion 1104 of the preamble includes a STF 1106, a LTF 1108, a U-SIG field 1110, and an IMMW-SIG field 1112. The non-legacy portion 1114 and may include a STF 1116, one or more LTFs 1118, an optional SIGB 1120, a payload that includes a data field 1122, and one or more PE or TRN fields 1124.

In some aspects, the legacy portion 1104 of the preamble may span the base bandwidth 1102. In a base bandwidth mode 1126, the PPDU may span the base bandwidth, and in the wider bandwidth mode 1128 the non legacy preamble portions 1136 and 1140 may occupy a wider bandwidth, and one instance 1134 of the legacy portion 1104 may be transmitted in the base bandwidth only as indicated at 1130, or multiple instances as indicated at 1138 of the legacy portion 1104 may be duplicated in the frequency domain 1132 to occupy the wider bandwidth. In some aspects, the legacy portion 1104 of the preamble may be power boosted relative to the non-legacy portion 1114 due to base bandwidth only transmission or frequency duplication combining. In some aspects, the base bandwidth may be 160 MHz, and the legacy portion 1104 may not be duplicated, and the PPDU format 1100 may correspond to an 802.11ac20 format that is upclocked by 8×, with a subcarrier spacing (SCS) of 2.5 MHz. In some aspects, the legacy portion 1104 may be duplicated in the frequency domain, and the base bandwidth 1102 may be 160 MHz, such that the PPDU format 1100 may correspond to an 802.11ac40 format that is upclocked by 4× and that has a 2× duplication, with a SCS of 1.25 MHz and a symbol duration is 0.8 us, which may provide additional margin for the legacy portion 1104 compared to the non-legacy portion 1114 (e.g., a 3 dB margin from 2× frequency domain duplication). In some aspects, the legacy portion 1104 may not be duplicated, the base bandwidth 1102 may be 160 MHz, and the legacy portion 1104 may be transmitted on a sub-band of 80 MHz, such that the legacy portion 1104 transmitted over 80 MHz corresponds to a PPDU format of 802.11ac20 that is upclocked by 4×, with remaining portions transmitted over the 160 MHz bandwidth, which may provide additional margin for the legacy portion 1104 compared to the non-legacy portion 1114 (e.g., a 3 dB margin from the sub-band transmission having an equivalent transmit power as transmissions over the base bandwidth 1102).

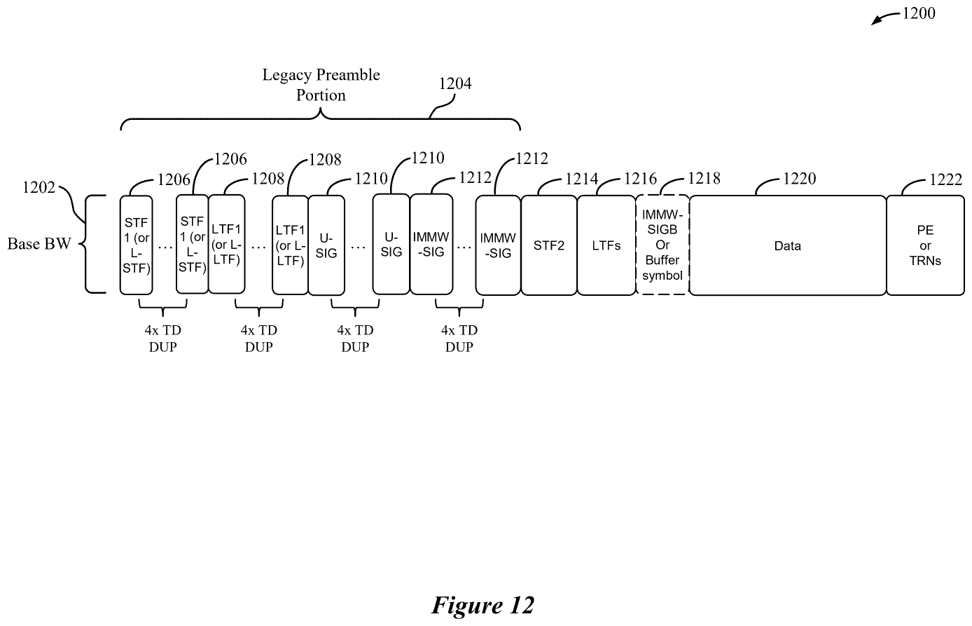

FIG. 12 shows an example of a PPDU format 1200 that supports physical layer protocol data unit formats for 60 GHz communications. In the example of FIG. 12, PPDU format 1200 may be transmitted in a base bandwidth 1202 in a base bandwidth mode (e.g., a smallest bandwidth allowed in an IMMW 60 GHz system, such as 160 MHz or 320 MHz), with fields of a legacy portion duplicated in the time domain to provide enhanced margin of the legacy portion over non-legacy portions of the PPDU format 1200.

The PPDU format 1200 shows an example data PPDU usable for communications between a wireless AP and one or more wireless STAs. For example, the AP and STAs may be examples of the AP 102 and the STAs 104 described with reference to FIG. 1. As shown, the PPDU format 1200 may span a base bandwidth 1202 (e.g., a 160 MHz or a 320 MHz base bandwidth) in a base bandwidth mode, and may span a larger bandwidth (e.g., 320 MHz or 640 MHz) in a wider bandwidth mode. In this example, the PPDU format 1200 includes a PHY preamble, that includes a legacy portion 1204 that occupies a bandwidth corresponding to the base bandwidth 1202, and a non-legacy portion that includes fields that are not in the legacy portion 1204. The legacy portion 1204 of the preamble includes fields that are duplicated in the time domain, such as a 4× time domain duplication, for a STF 1206, a LTF 1208, a U-SIG field 1210, and an IMMW-SIG field 1212. The non-legacy portion fields may not be duplicated in the time domain, and may include a STF 1214, one or more LTFs 1216, an optional SIGB or buffer symbol 1218, a payload that includes a data field 1220, and one or more PE or TRN fields 1222.

In some aspects, the time domain duplication provides a longer symbol with more margin. For example, for a 160 MHz base bandwidth 1202, the PPDU format 1200 may correspond to an 802.11ac20 PPDU that is upclocked by 8×, to provide a SCS of 2.5 MHz with 64FFT. In this example, a 4× time domain duplication (e.g. 4 STF 1206 and LTF 1208 symbols) to get 2 microseconds. In some aspects, a 4× time domain duplication provides about 6 dB of margin for the legacy portion 1204 relative to the non-legacy portions. Further, time domain duplication combining can be done in the time domain, so it can also provide some additional processing time at a receiving device.

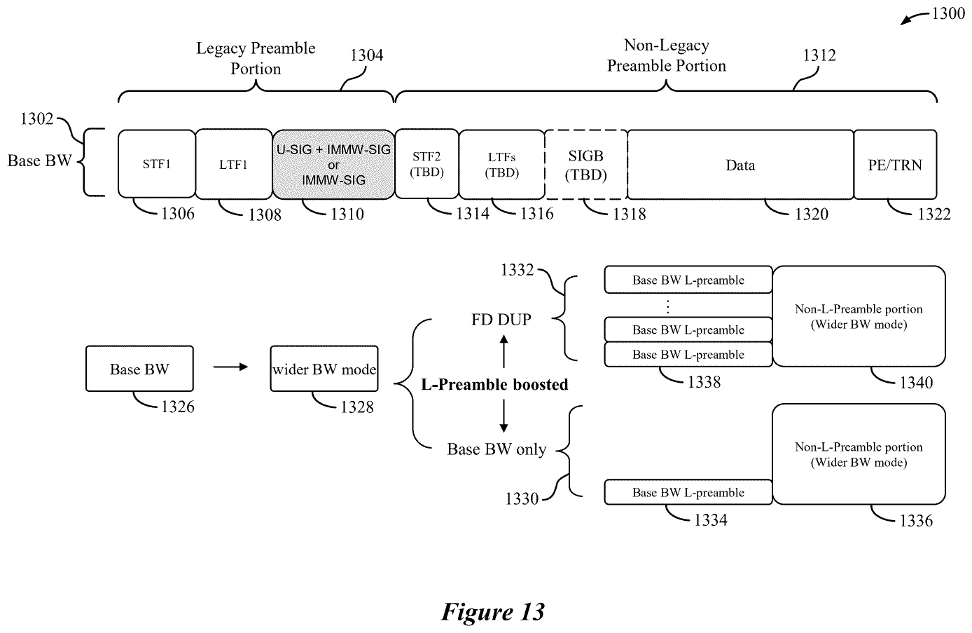

FIG. 13 shows an example of a PPDU format 1300 that supports physical layer protocol data unit formats for 60 GHz communications. In the example of FIG. 13, PPDU format 1300 may be transmitted in a base bandwidth 1302 in a base bandwidth mode (e.g., a smallest bandwidth allowed in an IMMW 60 GHz system, such as 160 MHz or 320 MHz), and in a wider bandwidth (e.g., according to an upclocked frame structure in which legacy preamble fields may occupy a different bandwidth than non-legacy fields) in a wider bandwidth mode.

The PPDU format 1300 shows an example data PPDU usable for communications between a wireless AP and one or more wireless STAs. For example, the AP and STAs may be examples of the AP 102 and the STAs 104 described with reference to FIG. 1. As shown, the PPDU format 1300 may span a base bandwidth 1302 (e.g., a 160 MHz or a 320 MHz base bandwidth) when in a base bandwidth mode, and may span a larger bandwidth (e.g., 320 MHz or 640 MHz) in a wider bandwidth mode. In this example, the PPDU format 1300 includes a PHY preamble, that includes a legacy portion 1304 that occupies a bandwidth corresponding to the base bandwidth 1302 without duplication, and a non-legacy portion 1312. The legacy portion 1304 of the preamble includes a STF 1306, a LTF 1308, and a U-SIG field+IMMW SIG field 1310 (which may include just an IMMW SIG). The non-legacy portion 1312 and may include a STF 1314, one or more LTFs 1316, an optional SIGB 1318, a payload that includes a data field 1320, and one or more PE or TRN fields 1322.

In some aspects, the legacy portion 1304 of the preamble may span the base bandwidth 1302. In a base bandwidth mode 1326, the PPDU may span the base bandwidth, and in the wider bandwidth mode 1328 the non-legacy preamble portions 1336 and 1340 may occupy a wider bandwidth, and one instance 1334 of the legacy portion 1304 may be transmitted in the base bandwidth only as indicated at 1330, or multiple instances as indicated at 1338 of the legacy portion 1304 may be duplicated in the frequency domain 1332 to occupy the wider bandwidth.

As discussed, in some aspects, the SIG field of the legacy portion 1304 may include only an IMMW SIG field 1310 (and not a U-SIG). In some aspects, the IMMW SIG field 1310 may include a set of parameters that include common parameters and demodulation parameters, as indicated in Table 1 below, and that include BRP parameters and SSW parameters, as indicate in Table 2 below.

TABLE 1
IMMW SIG Common and Demodulation Subfields

| | number | IMMW-SIG | |
|---|---|---|---|
| subfield name | of bits | Portion | Comments |
| PHY version ID | 3 | common | |
| BW | 1 or 2 | common | |
| PPDU type | 3 | common | regular, ELR (?), |
| | | | data + BRP, BRP, |
| | | | SSW, sub7 |
| | | | triggered NDP |
| PE/TRN switch | 1 | common | |
| | | (if needed) | |
| SIFS response | 1 | common | |
| | | (if needed) | |
| STA-ID | 11 | common | scheduled, |
| | | (if needed) | directional |
| BSS color | 6 | common | scheduled, |
| | | (if needed) | directional |
| TXOP | 7 | common | scheduled, |
| | | (if needed) | directional |
| DL/UL | 1 | common | scheduled, |
| | | (if needed) | directional |
| Total bits for common | 34 or 35 | | |
| CRC | 4 | | |
| Tail | 6 | | |
| Length | 13 or 14 | data | moved from |
| | | | common to data |
| | | | related |
| GI + LTF | 2 | data | |
| Number of LTF symbols | 3 or 6 | data/BRP-Rx | |
| Beamformed | 1 | Hybrid BF, | |
| | | data | |
| MCS | 5 | data | |
| Nss | 2 | data | |
| LDPC extra symbol | 1 | data | |
| segment | | | |
| 2x LDPC | 1 | data | |
| UEQM/MCS2 | 3 | data | for MIMO, can be |
| | | | per chain MCS |
| Interference mitigation | 1 | data | |
| Total bit for data demod | 32 or 36 | | |

TABLE 2
IMMW SIG BRP and SSW Subfields

| | number of | IMMW-SIG | |
|---|---|---|---|
| subfield name | bits | Portion | Comments |
| Training direction | 2 | BRP | |
| Beam tracking request | 1 | BRP | |
| Beam tracking request type | 1 | BRP | analog/baseband |
| | | | training, for |
| | | | MIMO |
| Number of Tx chains | 2 | BRP | for MIMO or |
| | | | channel |
| | | | aggregation |
| Dual polarization TRN | 1 | BRP | for MIMO |
| training | | | |
| Training length | 8 | BRP | |
| Rx TRN-units per each Tx | 8 | BRP | |
| TRN-unit | | | |
| TRN-unit P | 2 | BRP | |
| TRN-unit M | 4 | BRP | |
| TRN-unit N | 2 | BRP | |
| TRN subfield sequence | 2 | BRP | |
| length | | | |
| Rx pattern in BRP-Tx | 1 | BRP | quasi- |
| | | | omni/directional |
| | | | AWV |
| NUMBER of BITS for | 34 | | |
| BRP | | | |
| Training direction 1 | 1 | SSW | initiator or |
| | | | responder |
| Training direction 2 | 1 | SSW | Tx or Rx |
| Addressing mode | 1 | SSW | unicast or |
| | | | broadcast |
| MIDC indication | 1 | SSW | |
| Training length | 8 | SSW | |
| Count down | 11 | SSW | |
| RF chain ID | 2 | SSW | for MIMO or |
| | | | channel |
| | | | aggregation |
| Sector ID | 6 | SSW | |
| Antenna ID | 2 | SSW | |
| Number of Rx antennas or | 6 | SSW | |
| Rx patterns | | | |
| List of sector ID selected | 6 or 6*3 | SSW | |
| List of antenna ID selected | 2 or 2*3 | SSW | |
| SNR report | 8 or 8*3 | SSW | |
| Number of Tx chains | 2 | SSW | |
| NUMBER of BITS for | 57 or 89 | | |
| SSW | | | |

In some aspects, in accordance with Tables 1 and 2, the information included in the IMMW SIG field 1310 may depend on PPDU type. For example, for a regular data PPDU, the IMMW SIG field 1310 may include the common information and the data demodulation parameters. For a data plus beam refinement protocol (BRP) PPDU, the IMMW SIG field 1310 may include the common information, the data demodulation parameters, and the BRP related parameters. For a BRP null data packet (NDP) PPDU, the IMMW SIG field 1310 may include the common information plus the BRP related parameters. For a sector sweep (SSW) NDP PPDU, the IMMW SIG field 1310 may include the common information plus the SSW related parameters. In some aspects, a type of the PPDU in common information may be decoded first in order to determine other fields that may be included in the PPDU. In some aspects, the common information in the IMMW SIG field 1310 may be encoded separately from other portions of the IMMW SIG field 1310 (e.g., the data demodulation, BWP, and SSW parameters). For example, the common information plus the CRC (4 bits) and tail (6 bits) may be encoded, and then other parameters plus CRC (4 bits) and tail (6 bits) may be encoded, which may allow for the common information to be decoded separately and prior to decoding of the other parameters.

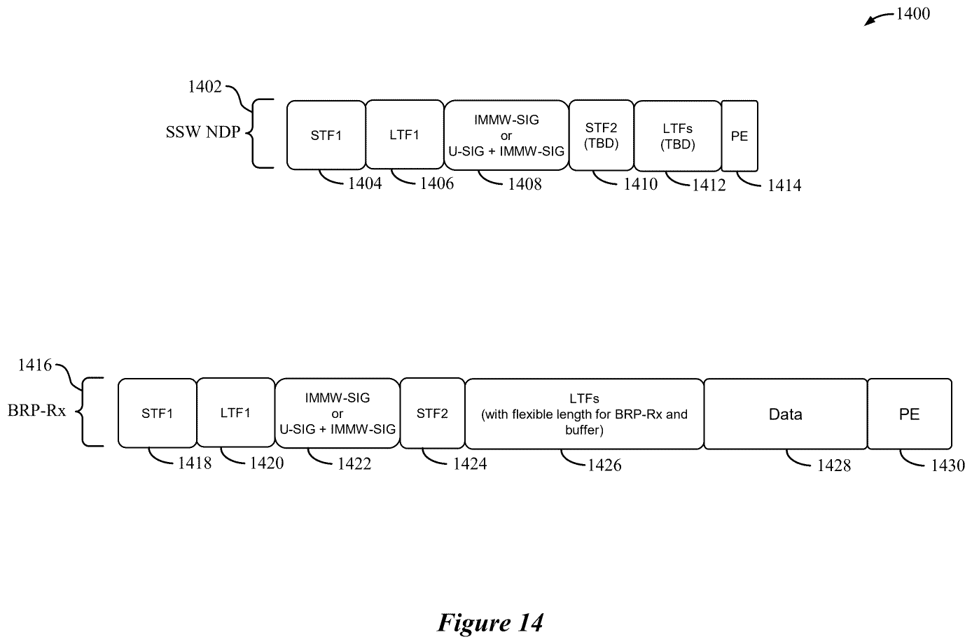

FIG. 14 shows an example of PPDU formats 1400 that supports beam selection and refinement for 60 GHz communications. In the example of FIG. 14, PPDU formats 1400 may include an SSW NDP PPDU format 1402 and a BRP-reception PPDU format 1416.

The PPDU formats 1400 show examples of PPDUs usable for communications, and beam selection and refinement, between a wireless AP and one or more wireless STAs. For example, the AP and STAs may be examples of the AP 102 and the STAs 104 described with reference to FIG. 1. In this example, the SSW NDP PPDU format 1402 may include an STF 1404 (e.g., 2~4 symbols or more repetitions), an LTF 1406 (e.g., 2 symbols or more with LTF repetition), a SIG 1408 (e.g., either an IMMW SIG field or a U-SIG plus an IMMW SIG field) with or without repetitions, a second STF 1410 (e.g., present if Nss>1), one or more LTFs 1412 (e.g., present if Nss>1), and a packet extension field 1414. Further, the BRP-reception PPDU format 1416 may include an STF 1418 (e.g., 2~4 symbols or more repetitions), an LTF 1420 (e.g., 2 symbols or more with LTF repetition), a SIG 1422 (e.g., either an IMMW SIG field or a U-SIG plus an IMMW SIG field) with or without repetitions, a second STF 1424 (e.g., present if Nss>1), one or more LTFs 1426 (e.g., present if Nss>1), an optional data field 1428 (e.g., in cases where data is provided with the PPDU), and a packet extension field 1430.

In some aspects, the PPDU formats 1400 may be used for beam selection, where a beam search can be done by beam scanning which may use a simpler PPDU format that consumes less overhead, and provides a coarse beam that may be selected for further refinement. In some aspects, multiple different PPDUs, such as with SSW NDP PPDU format 1402, may be transmitted in multiple different beamforming directions. Having a relatively simply PPDU format will help reduce overhead of such multiple different transmissions, many of which may not even be received at a receiving device. In some aspects, after a beam is selected, per element phase optimization, for transmission or reception, may be used for beam refinement to obtain a refined beam that is better than the coarse beam by, for example, 1-3 dB in the main lobe. In some aspects, per element phase optimization for reception may be performed, which may include a per receive antenna element phase check plus maximum ratio combining (MRC) at a receiver. In some examples, beam selection and refinement may be implementation specific at a receiver, and with same packet, a receiver may also do receive beam scanning. In some aspects, per element phase optimization for transmission also may be done through BRP-transmit techniques, in which a Hadamard matrix may be applied on an existing transmit antenna weight vector (AWV) in transmitting training (TRN) fields, to reconstruct the phases of each transmit antenna element at a receive by minimum mean square error (MMSE). Such techniques may thus be relatively complicated. In some aspects, to simplify the beam training procedure for IMMW and remove the need for TRN fields, transmit or transmit/receive beam training and refinement using the PPDU formats 1400 may use beam scanning through transmit sector level sweep (SLS) or transmit/receive SLS, and receive alone beam training and refinement may use BRP-reception PPDU format 1416 with a flexible length LTF 1426, which may be transmitted with or without data. Such techniques may thus simplify beam selection and refinement with relatively low overhead.

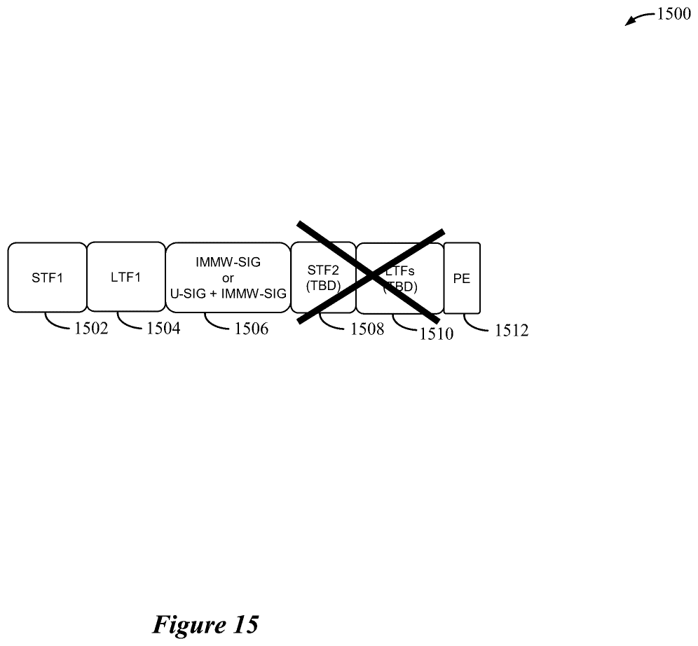

FIG. 15 shows an example of a PPDU format 1500 that supports beam selection and refinement for 60 GHz communications. In the example of FIG. 15, PPDU format 1500 may include a SSW NDP PPDU format PPDU in which a second STF 1508 and one or more second LTFs 1510 may be removed. The PPDU format 1500 shows an example of a PPDU usable for beam selection between a wireless AP and one or more wireless STAs. For example, the AP and STAs may be examples of the AP 102 and the STAs 104 described with reference to FIG. 1. In this example, the SSW NDP PPDU format may include an STF 1502 (e.g., 2~4 symbols or more repetitions), an LTF 1504 (e.g., 2 symbols or more with LTF repetition), a SIG 1506 (e.g., either an IMMW SIG field or a U-SIG plus an IMMW SIG field) with or without repetitions, and a packet extension field 1512. In some aspects, for beam scanning using SSW NDP packets, the receive side mainly measures signal strength or received power to determine which direction or sector has a best metric, which may be accomplished by using only STF 1502 and LTF 1504, therefore the second STF 1508 and one or more second LTFs 1510 may not be needed (e.g., especially for single input single output (SISO) cases).

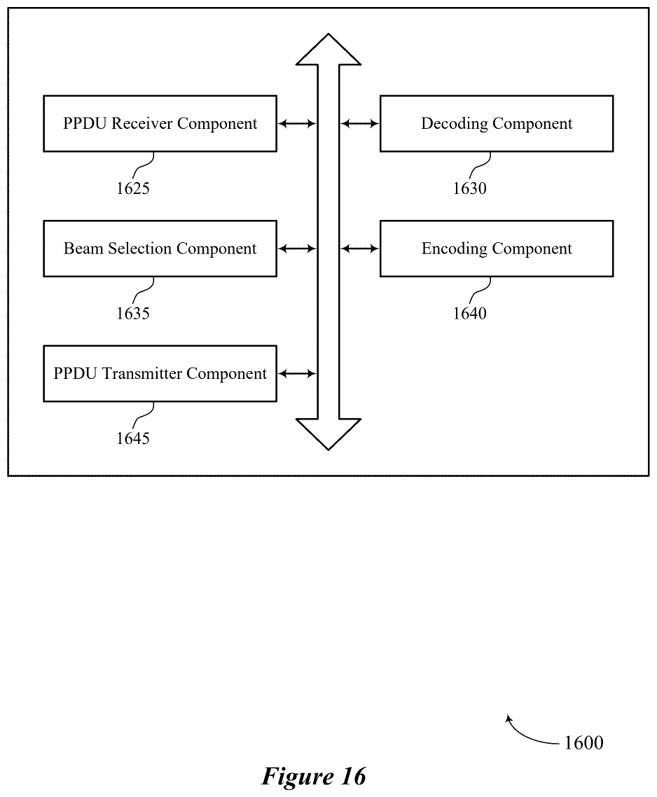

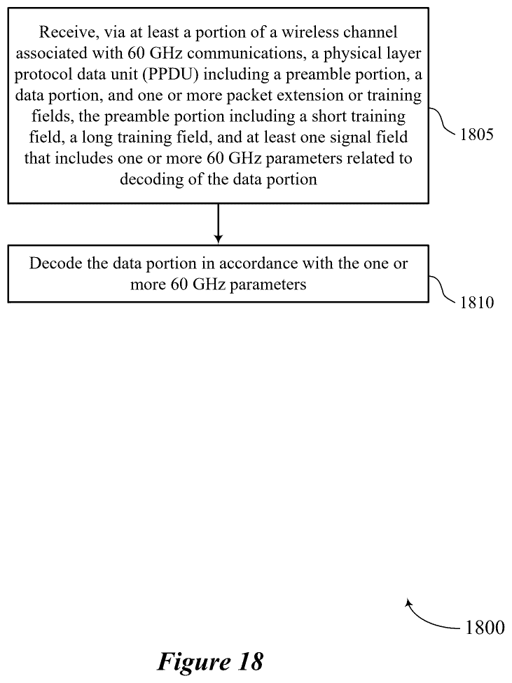

FIG. 16 shows a block diagram of an example wireless communication device 1600 that supports physical layer protocol data unit formats for 60 GHz communications. In some examples, the wireless communication device 1600 is configured to perform the processes 1800, 2000, 2100, 2200, and 2300 described with reference to FIGS. 18, 20, 21, 22, and 23, respectively. The wireless communication device 1600 may include one or more chips, SoCs, chipsets, packages, components or devices that individually or collectively constitute or include a processing system. The processing system may interface with other components of the wireless communication device 1600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1600 may transmit the information output from the chip. In such an example, the second interface may refer to an interface between the processing system of the chip and a reception component, such that the wireless communication device 1600 may receive information that is then passed to the processing system. In some such examples, the first interface also may obtain information, such as from the transmission component, and the second interface also may output information, such as to the reception component.

The processing system of the wireless communication device 1600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1600 can be configurable or configured for use in a STA, such as the STA 104 described with reference to FIG. 1. In some other examples, the wireless communication device 1600 can be a STA that includes such a processing system and other components including multiple antennas. The wireless communication device 1600 is capable of transmitting and receiving wireless communications in the form of, for example, wireless packets. For example, the wireless communication device 1600 can be configurable or configured to transmit and receive packets in the form of physical layer PPDUs and MPDUs conforming to one or more of the IEEE 802.11 family of wireless communication protocol standards. In some other examples, the wireless communication device 1600 can be configurable or configured to transmit and receive signals and communications conforming to one or more 3GPP specifications including those for 5G NR or 6G. In some examples, the wireless communication device 1600 also includes or can be coupled with one or more application processors which may be further coupled with one or more other memories. In some examples, the wireless communication device 1600 further includes a user interface (UI) (such as a touchscreen or keypad) and a display, which may be integrated with the UI to form a touchscreen display that is coupled with the processing system. In some examples, the wireless communication device 1600 may further include one or more sensors such as, for example, one or more inertial sensors, accelerometers, temperature sensors, pressure sensors, or altitude sensors, that are coupled with the processing system.

The wireless communication device 1600 includes a PPDU receiver component 1625, a decoding component 1630, and a beam selection component 1635, an encoding component 1640, and a PPDU transmitter component 1645. Portions of one or more of the PPDU receiver component 1625, the decoding component 1630, the beam selection component 1635, the encoding component 1640, and the PPDU transmitter component 1645 may be implemented at least in part in hardware or firmware. For example, one or more of the PPDU receiver component 1625, the decoding component 1630, the beam selection component 1635, the encoding component 1640, and the PPDU transmitter component 1645 may be implemented at least in part by at least a processor or a modem. In some examples, portions of one or more of the PPDU receiver component 1625, the decoding component 1630, the beam selection component 1635, the encoding component 1640, and the PPDU transmitter component 1645 may be implemented at least in part by a processor and software in the form of processor-executable code stored in memory.

The wireless communication device 1600 may support wireless communications in accordance with examples as disclosed herein. The PPDU receiver component 1625 is configurable or configured to receive, via at least a portion of a wireless channel associated with 60 GHz communications, a PPDU including a preamble portion, a data portion, and one or more packet extension or training fields, the preamble portion including a short training field, a long training field, and at least one signal field that includes one or more 60 GHz parameters related to decoding of the data portion. The decoding component 1630 is configurable or configured to decode the data portion in accordance with the one or more 60 GHz parameters.

In some examples, the PPDU has a frame structure that is upclocked from a PPDU frame structure associated with communications on one or more frequency bands that are lower than 60 GHz communications frequency bands.

In some examples, the preamble portion of the PPDU is upclocked at a smaller ratio than the data portion of the PPDU, and provides that one or more legacy fields of the preamble portion have a same tone spacing and symbol duration as the data portion. In some examples, the preamble portion of the PPDU spans multiple sub-bands of a bandwidth of the wireless channel, and the short training field, the long training field, and the at least one signal field are duplicated across multiple sub-bands, and the data portion spans all of the sub-bands of the bandwidth of the wireless channel.

In some examples, at least the short training field, the long training field, and at least one signal field of the preamble portion are upclocked from corresponding fields of a PPDU frame structure associated with communications on one or more frequency bands that are lower than 60 GHz communications frequency bands, and the at least one signal field includes an integrated millimeter wave (IMMW) signal field that is associated with 60 GHz communications. In some examples, the IMMW signal field includes legacy signal field information that is jointly encoded with one or more parameters associated with 60 GHz communications.

In some examples, the IMMW signal field includes one or more version independent fields that are independent of a protocol version associated with the PPDU and one or more version dependent fields in accordance with the protocol version associated with the PPDU, and where the one or more version independent fields and the one or more version dependent fields are jointly encoded or are separately encoded. In some examples, the at least one signal field includes a universal signal (U-SIG) field and the IMMW signal field. In some examples, a modulation scheme used to modulate the one or more signal fields of the preamble portion indicates a format or a variation associated with the PPDU. In some examples, the modulation scheme is selected from a binary phase-shift keying (BPSK) or a quadrature BPSK (QBPSK) modulation scheme.

In some examples, the preamble portion includes a legacy short training field (L-STF) and a legacy long training field (L-LTF) that are duplicated in each sub-band of a set of multiple sub-bands of a channel bandwidth of the wireless channel. In some examples, the one or more signal fields span all of the set of multiple sub-bands. In some examples, the preamble portion includes a legacy short training field (L-STF) and a legacy long training field (L-LTF) that are duplicated in each sub-band of a set of multiple sub-bands of a channel bandwidth of the wireless channel. In some examples, the one or more signal fields are duplicated in one or more smallest schedulable bandwidth blocks that each span two or more sub-bands of the set of multiple sub-bands.

In some examples, the preamble portion includes one or more legacy fields that are transmitted via a first portion of a channel bandwidth of the wireless channel. In some examples, one or more non-legacy fields of the preamble portion, and the data portion, are transmitted using a second portion of the channel bandwidth that is larger than the first portion of the channel bandwidth, where the first portion is a subset or a sub-band of the second portion. In some examples, the one or more legacy fields are encoded in accordance with a 64 point fast Fourier transform, and have a same tone spacing as the data portion. In some examples, the first portion of a channel bandwidth corresponds to a smallest schedulable sub-band of the channel bandwidth irrespective of a size of the second portion of the channel bandwidth. In some examples, the preamble portion uses a same tone plan and a same numerology as the data portion.

In some examples, the data portion includes control information that provides one or more of a ready to send (RTS) indication, a clear to send (CTS) indication, block acknowledgment (BA) information, or acknowledgment (ACK) information associated with wireless communications between the STA and an access point. In some examples, the control information is transmitted in a medium access control (MAC) control frame included in the data portion using a smallest schedulable channel bandwidth of the wireless channel. In some examples, the PPDU is transmitted with increased power relative to a transmission that spans all sub-bands of a set of multiple sub-bands of a bandwidth of the wireless channel. In some examples, the control information is transmitted in a medium access control (MAC) control frame included in the data portion using. In some examples, the PPDU is encoded over a smallest schedulable bandwidth and duplicated on two or more smallest bandwidth blocks that forma channel bandwidth of the wireless channel.

In some examples, the PPDU is an enhanced long range (ELR) PPDU and includes one or more extension fields subsequent to the data portion. In some examples, the PPDU is transmitted in accordance with one or more of power boosting, a lower coding rate, a lower modulation order, or signal repetition, relative to a non-ELR PPDU.

Additionally, or alternatively, the wireless communication device 1600 may support wireless communications in accordance with examples as disclosed herein. The PPDU receiver component 1625 is configurable or configured to receive, via at least a portion of a wireless channel associated with 60 GHz communications, a PPDU including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion. The decoding component 1630 is configurable or configured to decode the data portion in accordance with the one or more 60 GHz parameters.

In some examples, the legacy preamble portion spans all sub-bands of the bandwidth of the wireless channel. In some examples, a first instance of the legacy preamble portion spans a first subset of sub-bands of the bandwidth of the wireless channel, and a second duplicated instance of the legacy preamble portion spans a second subset of sub-bands of the bandwidth of the wireless channel. In some examples, the legacy preamble portion spans a subset of sub-bands of the bandwidth of the wireless channel, and is transmitted with increased power relative to the non-legacy preamble portion that spans all of the sub-bands of the bandwidth of the wireless channel. In some examples, two or more instances of the legacy preamble portion are duplicated in time on the one or more sub-bands of the bandwidth of the wireless channel. In some examples, the legacy preamble portion includes a short training field, a long training field, and at least one signal field that are each duplicated in time on the one or more sub-bands of the bandwidth of the wireless channel.

In some examples, the one or more sub-bands include sub-bands each have a bandwidth associated with a base bandwidth mode or smallest bandwidth allowed in an IMMW 60 GHz communications system. In some examples, the at least one signal field includes an integrated millimeter wave (IMMW) signal field that is associated with 60 GHz communications. In some examples, the IMMW signal field includes a common portion, and one or more of a data demodulation portion, a BRP portion, or a SSW portion. In some examples, the common portion of the IMMW signal field is separately encoded from other portions of the IMMW signal field. In some examples, the common portion of the IMMW signal field includes an indication of a PPDU type of the PPDU, and where the PPDU type indicates which of the data demodulation portion, the BRP portion, or the SSW portion are included in the IMMW signal field.

Additionally, or alternatively, the wireless communication device 1600 may support wireless communications in accordance with examples as disclosed herein. In some examples, the PPDU receiver component 1625 is configurable or configured to receive, via at least a portion of a wireless channel associated with 60 GHz communications, one or more first PPDUs having a first format for beam selection. The beam selection component 1635 is configurable or configured to select a first beam for communications based on the one or more first PPDUs. In some examples, the PPDU receiver component 1625 is configurable or configured to receive, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

In some examples, the one or more first PPDUs are SSW PPDUs that are transmitted using different beams, and where the SSW PPDUs are NDP PPDUs. In some examples, the second PPDU is a BRP PPDU that is transmitted with or without an associated data portion. In some examples, the BRP PPDU includes a flexible length long training field that includes one or more signals for refinement of receive beamforming parameters. In some examples, the one or more first PPDUs are SSW PPDUs that include only a legacy preamble portion that includes a STF, a LTF, and a SIG field.

Additionally, or alternatively, the wireless communication device 1600 may support wireless communications in accordance with examples as disclosed herein. The encoding component 1640 is configurable or configured to encode a data portion of a PPDU in accordance with one or more 60 GHz parameters associated with 60 GHz communications. The PPDU transmitter component 1645 is configurable or configured to transmit, via at least a portion of a wireless channel associated with 60 GHz communications, the PPDU to at least one STA, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion.

In some examples, the legacy preamble portion spans all sub-bands of the bandwidth of the wireless channel. In some examples, a first instance of the legacy preamble portion spans a first subset of sub-bands of the bandwidth of the wireless channel, and a second duplicated instance of the legacy preamble portion spans a second subset of sub-bands of the bandwidth of the wireless channel. In some examples, the legacy preamble portion spans a subset of sub-bands of the bandwidth of the wireless channel, and is transmitted with increased power relative to the non-legacy preamble portion that spans all of the sub-bands of the bandwidth of the wireless channel. In some examples, two or more instances of the legacy preamble portion are duplicated in time on the one or more sub-bands of the bandwidth of the wireless channel. In some examples, the legacy preamble portion includes a short training field, a long training field, and at least one signal field that are each duplicated in time on the one or more sub-bands of the bandwidth of the wireless channel.

In some examples, the one or more sub-bands include sub-bands each have a bandwidth associated with a base bandwidth mode or smallest bandwidth allowed in an IMMW 60 GHz communications system. In some examples, the at least one signal field includes an integrated millimeter wave (IMMW) signal field that is associated with 60 GHz communications. In some examples, the IMMW signal field includes a common portion, and one or more of a data demodulation portion, a beam refinement parameter (BRP) portion, or a sector sweep (SSW) portion. In some examples, the common portion of the IMMW signal field is separately encoded from other portions of the IMMW signal field. In some examples, the common portion of the IMMW signal field includes an indication of a PPDU type of the PPDU, and where the PPDU type indicates which of the data demodulation portion, the BRP portion, or the SSW portion are included in the IMMW signal field.

Additionally, or alternatively, the wireless communication device 1600 may support wireless communications in accordance with examples as disclosed herein. In some examples, the PPDU transmitter component 1645 is configurable or configured to transmit, via at least a portion of a wireless channel associated with 60 GHz communications, one or more first physical layer protocol data units (PPDUs) having a first format for beam selection. In some examples, the PPDU transmitter component 1645 is configurable or configured to transmit, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

In some examples, the one or more first PPDUs are SSW PPDUs that are transmitted using different beams, and where the SSW PPDUs are NDP PPDUs. In some examples, the second PPDU is a BRP PPDU that is transmitted with or without an associated data portion. In some examples, the BRP PPDU includes a flexible length long training field that includes one or more signals for refinement of receive beamforming parameters. In some examples, the one or more first PPDUs are SSW PPDUs that include only a legacy preamble portion that includes a STF, a LTF, and a SIG field.

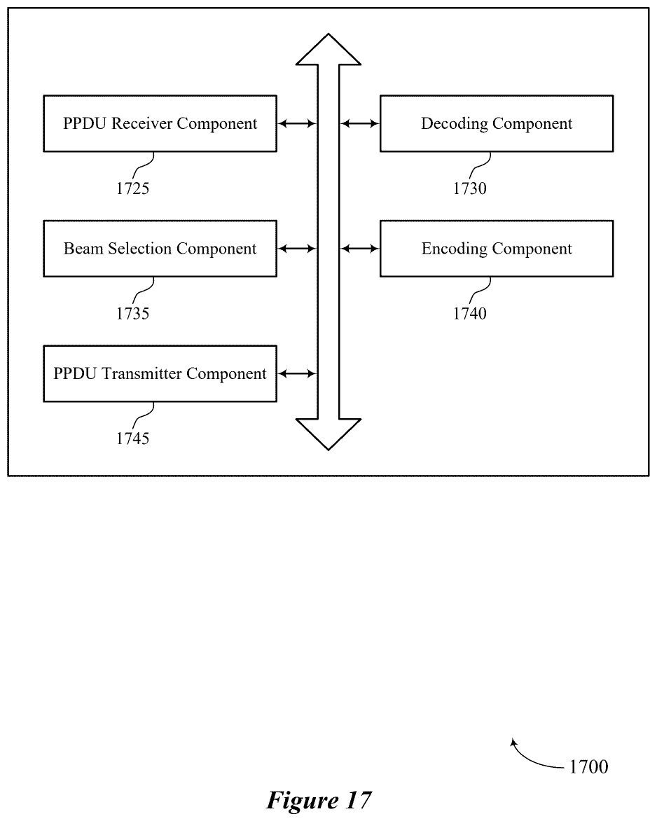

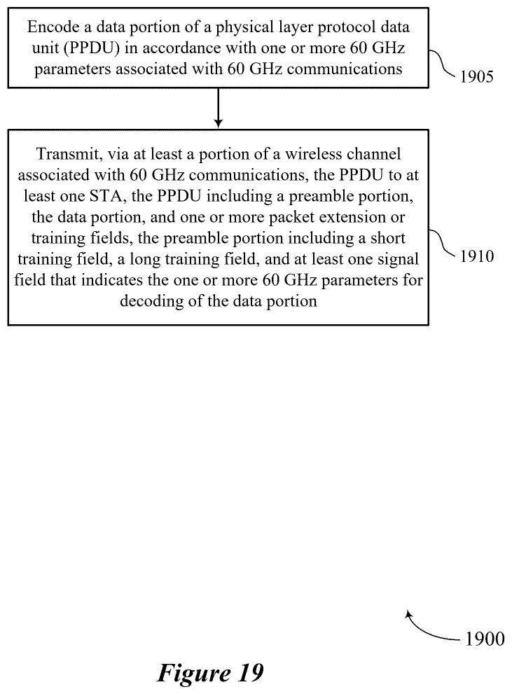

FIG. 17 shows a block diagram of an example wireless communication device 1700 that supports physical layer protocol data unit formats for 60 GHz communications. In some examples, the wireless communication device 1700 is configured to perform the processes 1900, 2100, 2200, and 2300 described with reference to FIGS. 19, 21, 22, and 23, respectively. The wireless communication device 1700 may include one or more chips, SoCs, chipsets, packages, components or devices that individually or collectively constitute or include a processing system. The processing system may interface with other components of the wireless communication device 1700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1700 may transmit the information output from the chip. In such an example, the second interface may refer to an interface between the processing system of the chip and a reception component, such that the wireless communication device 1700 may receive information that is then passed to the processing system. In some such examples, the first interface also may obtain information, such as from the transmission component, and the second interface also may output information, such as to the reception component.

The processing system of the wireless communication device 1700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1700 can be configurable or configured for use in an AP, such as the AP 102 described with reference to FIG. 1. In some other examples, the wireless communication device 1700 can be an AP that includes such a processing system and other components including multiple antennas. The wireless communication device 1700 is capable of transmitting and receiving wireless communications in the form of, for example, wireless packets. For example, the wireless communication device 1700 can be configurable or configured to transmit and receive packets in the form of physical layer PPDUs and MPDUs conforming to one or more of the IEEE 802.11 family of wireless communication protocol standards. In some other examples, the wireless communication device 1700 can be configurable or configured to transmit and receive signals and communications conforming to one or more 3GPP specifications including those for 5G NR or 6G. In some examples, the wireless communication device 1700 also includes or can be coupled with one or more application processors which may be further coupled with one or more other memories. In some examples, the wireless communication device 1700 further includes at least one external network interface coupled with the processing system that enables communication with a core network or backhaul network that enables the wireless communication device 1700 to gain access to external networks including the Internet.

The wireless communication device 1700 includes a PPDU receiver component 1725, a decoding component 1730, a beam selection component 1735, an encoding component 1740, and a PPDU transmitter component 1745. Portions of one or more of the PPDU receiver component 1725, the decoding component 1730, the beam selection component 1735, the encoding component 1740, and the PPDU transmitter component 1745 may be implemented at least in part in hardware or firmware. For example, one or more of the PPDU receiver component 1725, the decoding component 1730, the beam selection component 1735, the encoding component 1740, and the PPDU transmitter component 1745 may be implemented at least in part by at least a processor or a modem. In some examples, portions of one or more of the PPDU receiver component 1725, the decoding component 1730, the beam selection component 1735, the encoding component 1740, and the PPDU transmitter component 1745 may be implemented at least in part by a processor and software in the form of processor-executable code stored in memory.

The wireless communication device 1700 may support wireless communications in accordance with examples as disclosed herein. The encoding component 1740 is configurable or configured to encode a data portion of a PPDU in accordance with one or more 60 GHz parameters associated with 60 GHz communications. The PPDU transmitter component 1745 is configurable or configured to transmit, via at least a portion of a wireless channel associated with 60 GHz communications, the PPDU to at least one other wireless device (e.g., an AP or a STA), the PPDU including a preamble portion, the data portion, and one or more packet extension or training fields, the preamble portion including a short training field, a long training field, and at least one signal field that indicates the one or more 60 GHz parameters for decoding of the data portion.

In some examples, the PPDU has a frame structure that is upclocked from a PPDU frame structure associated with communications on one or more frequency bands that are lower than 60 GHz communications frequency bands. In some examples, the preamble portion of the PPDU is upclocked at a smaller ratio than the data portion of the PPDU, and provides that one or more legacy fields of the preamble portion have a same tone spacing and symbol duration as the data portion. In some examples, the preamble portion of the PPDU spans multiple sub-bands of a bandwidth of the wireless channel, and the short training field, the long training field, and the at least one signal field are duplicated across multiple sub-bands, and the data portion spans all of the sub-bands of the bandwidth of the wireless channel.

In some examples, at least the short training field, the long training field, and at least one signal field of the preamble portion are upclocked from corresponding fields of a PPDU frame structure associated with communications on one or more frequency bands that are lower than 60 GHz communications frequency bands, and the at least one signal field includes an integrated millimeter wave (IMMW) signal field that is associated with 60 GHz communications. In some examples, the IMMW signal field includes legacy signal field information that is jointly encoded with one or more parameters associated with 60 GHz communications. In some examples, the IMMW signal field includes one or more version independent fields that are independent of a protocol version associated with the PPDU and one or more version dependent fields in accordance with the protocol version associated with the PPDU, and where the one or more version independent fields and the one or more version dependent fields are jointly encoded or are separately encoded. In some examples, the at least one signal field includes a universal signal (U-SIG) field and the IMMW signal field. In some examples, a modulation scheme used to modulate the one or more signal fields of the preamble portion indicates a format or a variation associated with the PPDU. In some examples, the modulation scheme is selected from a binary phase-shift keying (BPSK) or a quadrature BPSK (QBPSK) modulation scheme.

In some examples, the preamble portion includes a legacy short training field (L-STF) and a legacy long training field (L-LTF) that are duplicated in each sub-band of a set of multiple sub-bands of a channel bandwidth of the wireless channel. In some examples, the one or more signal fields span all of the set of multiple sub-bands. In some examples, the preamble portion includes a legacy short training field (L-STF) and a legacy long training field (L-LTF) that are duplicated in each sub-band of a set of multiple sub-bands of a channel bandwidth of the wireless channel. In some examples, the one or more signal fields are duplicated in one or more smallest schedulable bandwidth blocks that each span two or more sub-bands of the set of multiple sub-bands.

In some examples, the preamble portion includes one or more legacy fields that are transmitted via a first portion of a channel bandwidth of the wireless channel. In some examples, one or more non-legacy fields of the preamble portion, and the data portion, are transmitted using a second portion of the channel bandwidth that is larger than the first portion of the channel bandwidth, where the first portion is a subset or a sub-band of the second portion. In some examples, the one or more legacy fields are encoded in accordance with a 64 point fast Fourier transform, and have a same tone spacing as the data portion. In some examples, the first portion of a channel bandwidth corresponds to a smallest schedulable sub-band of the channel bandwidth irrespective of a size of the second portion of the channel bandwidth. In some examples, the preamble portion uses a same tone plan and a same numerology as the data portion.

In some examples, the data portion includes control information that provides one or more of a ready to send (RTS) indication, a clear to send (CTS) indication, block acknowledgment (BA) information, or acknowledgment (ACK) information associated with wireless communications between the STA and an access point. In some examples, the control information is transmitted in a medium access control (MAC) control frame included in the data portion using a smallest schedulable channel bandwidth of the wireless channel. In some examples, the PPDU is transmitted with increased power relative to a transmission that spans all sub-bands of a set of multiple sub-bands of the channel bandwidth. In some examples, the control information is transmitted in a medium access control (MAC) control frame included in the data portion using. In some examples, the PPDU is encoded over a smallest schedulable bandwidth and duplicated on two or more smallest bandwidth blocks that forma channel bandwidth of the wireless channel.

In some examples, the PPDU is an enhanced long range (ELR) PPDU and includes one or more extension fields subsequent to the data portion. In some examples, the PPDU is transmitted in accordance with one or more of power boosting, a lower coding rate, a lower modulation order, or signal repetition, relative to a non-ELR PPDU.

Additionally, or alternatively, the wireless communication device 1700 may support wireless communications in accordance with examples as disclosed herein. The PPDU receiver component 1725 is configurable or configured to receive, via at least a portion of a wireless channel associated with 60 GHz communications, a PPDU including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion. The decoding component 1730 is configurable or configured to decode the data portion in accordance with the one or more 60 GHz parameters.

In some examples, the legacy preamble portion spans all sub-bands of the bandwidth of the wireless channel. In some examples, a first instance of the legacy preamble portion spans a first subset of sub-bands of the bandwidth of the wireless channel, and a second duplicated instance of the legacy preamble portion spans a second subset of sub-bands of the bandwidth of the wireless channel. In some examples, the legacy preamble portion spans a subset of sub-bands of the bandwidth of the wireless channel, and is transmitted with increased power relative to the non-legacy preamble portion that spans all of the sub-bands of the bandwidth of the wireless channel. In some examples, two or more instances of the legacy preamble portion are duplicated in time on the one or more sub-bands of the bandwidth of the wireless channel. In some examples, the legacy preamble portion includes a short training field, a long training field, and at least one signal field that are each duplicated in time on the one or more sub-bands of the bandwidth of the wireless channel. In some examples, the one or more sub-bands include sub-bands each have a bandwidth associated with a base bandwidth mode or smallest bandwidth allowed in an IMMW 60 GHz communications system.

In some examples, the at least one signal field includes an IMMW signal field that is associated with 60 GHz communications. In some examples, the IMMW signal field includes a common portion, and one or more of a data demodulation portion, a BRP portion, or a SSW portion. In some examples, the common portion of the IMMW signal field is separately encoded from other portions of the IMMW signal field. In some examples, the common portion of the IMMW signal field includes an indication of a PPDU type of the PPDU, and where the PPDU type indicates which of the data demodulation portion, the BRP portion, or the SSW portion are included in the IMMW signal field.

Additionally, or alternatively, the wireless communication device 1700 may support wireless communications in accordance with examples as disclosed herein. In some examples, the PPDU receiver component 1725 is configurable or configured to receive, via at least a portion of a wireless channel associated with 60 GHz communications, one or more first PPDUs having a first format for beam selection. The beam selection component 1735 is configurable or configured to select a first beam for communications based on the one or more first PPDUs. In some examples, the PPDU receiver component 1725 is configurable or configured to receive, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

In some examples, the one or more first PPDUs are SSW PPDUs that are transmitted using different beams, and where the SSW PPDUs are NDP PPDUs. In some examples, the second PPDU is a BRP PPDU that is transmitted with or without an associated data portion. In some examples, the BRP PPDU includes a flexible length long training field that includes one or more signals for refinement of receive beamforming parameters. In some examples, the one or more first PPDUs are SSW PPDUs that include only a legacy preamble portion that includes a STF, a LTF, and a SIG field.

Additionally, or alternatively, the wireless communication device 1700 may support wireless communications in accordance with examples as disclosed herein. The encoding component 1740 is configurable or configured to encode a data portion of a PPDU in accordance with one or more 60 GHz parameters associated with 60 GHz communications. The PPDU transmitter component 1745 is configurable or configured to transmit, via at least a portion of a wireless channel associated with 60 GHz communications, the PPDU to at least one STA, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion.

In some examples, the legacy preamble portion spans all sub-bands of the bandwidth of the wireless channel. In some examples, a first instance of the legacy preamble portion spans a first subset of sub-bands of the bandwidth of the wireless channel, and a second duplicated instance of the legacy preamble portion spans a second subset of sub-bands of the bandwidth of the wireless channel. In some examples, the legacy preamble portion spans a subset of sub-bands of the bandwidth of the wireless channel, and is transmitted with increased power relative to the non-legacy preamble portion that spans all of the sub-bands of the bandwidth of the wireless channel. In some examples, two or more instances of the legacy preamble portion are duplicated in time on the one or more sub-bands of the bandwidth of the wireless channel. In some examples, the legacy preamble portion includes a short training field, a long training field, and at least one signal field that are each duplicated in time on the one or more sub-bands of the bandwidth of the wireless channel.

In some examples, the one or more sub-bands include sub-bands each have a bandwidth associated with a base bandwidth mode or smallest bandwidth allowed in an IMMW 60 GHz communications system. In some examples, the at least one signal field includes an IMMW signal field that is associated with 60 GHz communications. In some examples, the IMMW signal field includes a common portion, and one or more of a data demodulation portion, a BRP portion, or a SSW portion. In some examples, the common portion of the IMMW signal field is separately encoded from other portions of the IMMW signal field. In some examples, the common portion of the IMMW signal field includes an indication of a PPDU type of the PPDU, and where the PPDU type indicates which of the data demodulation portion, the BRP portion, or the SSW portion are included in the IMMW signal field.

Additionally, or alternatively, the wireless communication device 1700 may support wireless communications in accordance with examples as disclosed herein. In some examples, the PPDU transmitter component 1745 is configurable or configured to transmit, via at least a portion of a wireless channel associated with 60 GHz communications, one or more first PPDUs having a first format for beam selection. In some examples, the PPDU transmitter component 1745 is configurable or configured to transmit, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU.

In some examples, the one or more first PPDUs are SSW PPDUs that are transmitted using different beams, and where the SSW PPDUs are NDP PPDUs. In some examples, the second PPDU is a BRP PPDU that is transmitted with or without an associated data portion. In some examples, the BRP PPDU includes a flexible length long training field that includes one or more signals for refinement of receive beamforming parameters. In some examples, the one or more first PPDUs are SSW PPDUs that include only a legacy preamble portion that includes a STF, a LTF, and a SIG field.

FIG. 18 shows a flowchart illustrating an example process 1800 performable by or at a wireless STA that supports physical layer protocol data unit formats for 60 GHz communications. The operations of the process 1800 may be implemented by a wireless STA or its components as described herein. For example, the process 1800 may be performed by a wireless communication device, such as the wireless communication device 1600 described with reference to FIG. 16, operating as or within a wireless STA. In some examples, the process 1800 may be performed by a wireless STA, such as one of the STAs 104 described with reference to FIG. 1.

In some examples, in 1805, the wireless STA may receive, via at least a portion of a wireless channel associated with 60 GHz communications, a PPDU including a preamble portion, a data portion, and one or more packet extension or training fields, the preamble portion including a short training field, a long training field, and at least one signal field that includes one or more 60 GHz parameters related to decoding of the data portion. In some implementations, aspects of the operations of 1805 may be performed by a PPDU receiver component 1625 as described with reference to FIG. 16.

In some examples, in 1810, the wireless STA may decode the data portion in accordance with the one or more 60 GHz parameters. In some implementations, aspects of the operations of 1810 may be performed by a decoding component 1630 as described with reference to FIG. 16.

FIG. 19 shows a flowchart illustrating an example process 1900 performable by or at a wireless AP that supports physical layer protocol data unit formats for 60 GHz communications. The operations of the process 1900 may be implemented by a wireless AP or its components as described herein. For example, the process 1900 may be performed by a wireless communication device, such as the wireless communication device 1700 described with reference to FIG. 17, operating as or within a wireless AP. In some examples, the process 1900 may be performed by a wireless AP, such as one of the APs 102 described with reference to FIG. 1.

In some examples, in 1905, the wireless AP may encode a data portion of a PPDU in accordance with one or more 60 GHz parameters associated with 60 GHz communications. In some implementations, aspects of the operations of 1905 may be performed by an encoding component 1740 as described with reference to FIG. 17.

In some examples, in 1910, the wireless AP may transmit, via at least a portion of a wireless channel associated with 60 GHz communications, the PPDU to at least one STA, the PPDU including a preamble portion, the data portion, and one or more packet extension or training fields, the preamble portion including a short training field, a long training field, and at least one signal field that indicates the one or more 60 GHz parameters for decoding of the data portion. In some implementations, aspects of the operations of 1910 may be performed by a PPDU transmitter component 1745 as described with reference to FIG. 17.

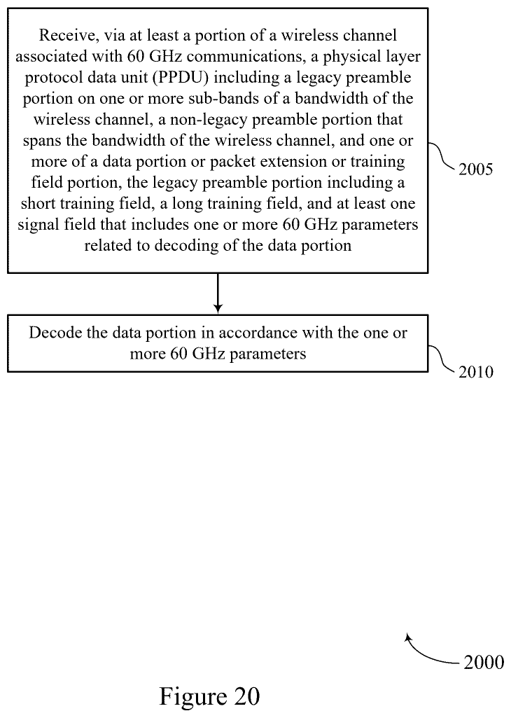

FIG. 20 shows a flowchart illustrating an example process 2000 performable by or at a wireless device that supports physical layer protocol data unit formats for 60 GHz communications. The operations of the process 2000 may be implemented by a wireless device or its components as described herein. For example, the process 2000 may be performed by a wireless communication device, such as the wireless communication device 1600 described with reference to FIG. 16, operating as or within a wireless AP or a wireless STA. In some examples, the process 2000 may be performed by a wireless AP or a wireless STA, such as one of the APs 102 or the STAs 104 described with reference to FIG. 1.

In some examples, in 2005, the wireless device may receive, via at least a portion of a wireless channel associated with 60 GHz communications, a physical layer protocol data unit (PPDU) including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion. In some implementations, aspects of the operations of 2005 may be performed by a PPDU receiver component 1625 as described with reference to FIG. 16.

In some examples, in 2010, the wireless device may decode the data portion in accordance with the one or more 60 GHz parameters. In some implementations, aspects of the operations of 2010 may be performed by a decoding component 1630 as described with reference to FIG. 16.

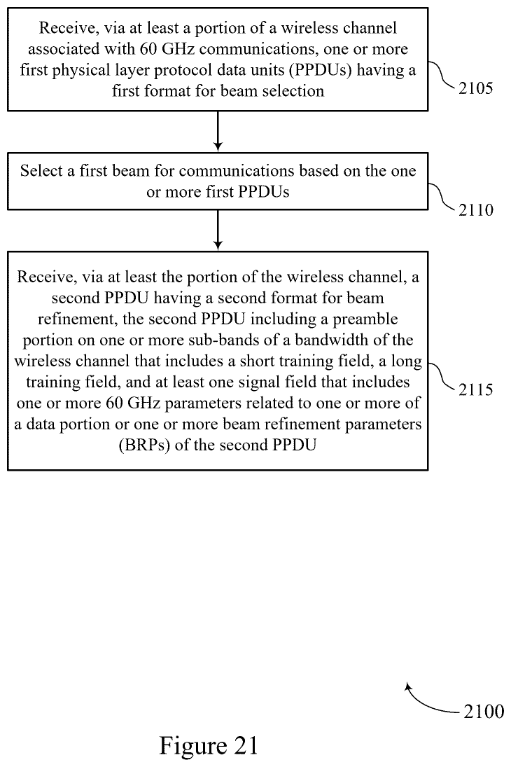

FIG. 21 shows a flowchart illustrating an example process 2100 performable by or at a wireless device that supports physical layer protocol data unit formats for 60 GHz communications. The operations of the process 2100 may be implemented by a wireless device or its components as described herein. For example, the process 2100 may be performed by a wireless communication device, such as the wireless communication device 1600 described with reference to FIG. 16, operating as or within a wireless AP or a wireless STA. In some examples, the process 2100 may be performed by a wireless AP or a wireless STA, such as one of the APs 102 or the STAs 104 described with reference to FIG. 1.

In some examples, in 2105, the wireless device may receive, via at least a portion of a wireless channel associated with 60 GHz communications, one or more first PPDUs having a first format for beam selection. In some implementations, aspects of the operations of 2105 may be performed by a PPDU receiver component 1625 as described with reference to FIG. 16.

In some examples, in 2110, the wireless device may select a first beam for communications based on the one or more first PPDUs. In some implementations, aspects of the operations of 2110 may be performed by a beam selection component 1635 as described with reference to FIG. 16.

In some examples, in 2115, the wireless device may receive, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU. In some implementations, aspects of the operations of 2115 may be performed by a PPDU receiver component 1625 as described with reference to FIG. 16.

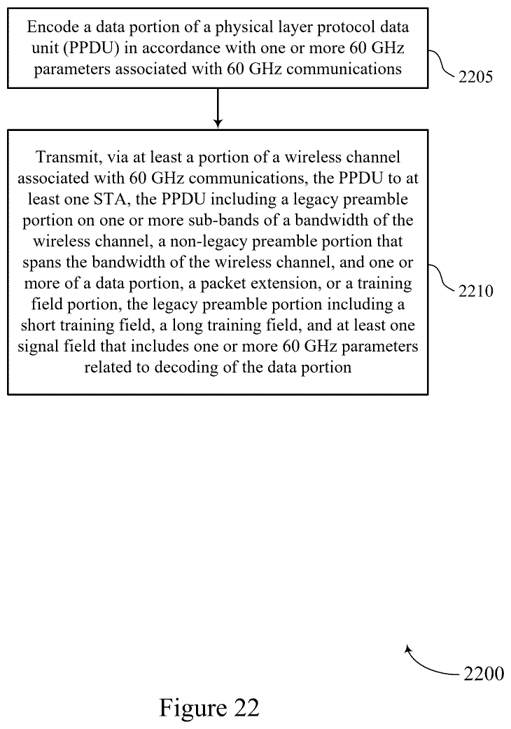

FIG. 22 shows a flowchart illustrating an example process 2200 performable by or at a wireless device that supports physical layer protocol data unit formats for 60 GHz communications. The operations of the process 2200 may be implemented by a wireless device or its components as described herein. For example, the process 2200 may be performed by a wireless communication device, such as the wireless communication device 1700 described with reference to FIG. 17, operating as or within a wireless AP or a wireless STA. In some examples, the process 2200 may be performed by a wireless AP or a wireless STA, such as one of the APs 102 or the STAs 104 described with reference to FIG. 1.

In some examples, in 2205, the wireless device may encode a data portion of a physical layer protocol data unit (PPDU) in accordance with one or more 60 GHz parameters associated with 60 GHz communications. In some implementations, aspects of the operations of 2205 may be performed by an encoding component 1740 as described with reference to FIG. 17.

In some examples, in 2210, the wireless device may transmit, via at least a portion of a wireless channel associated with 60 GHz communications, the PPDU to at least one STA, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion. In some implementations, aspects of the operations of 2210 may be performed by a PPDU transmitter component 1745 as described with reference to FIG. 17.

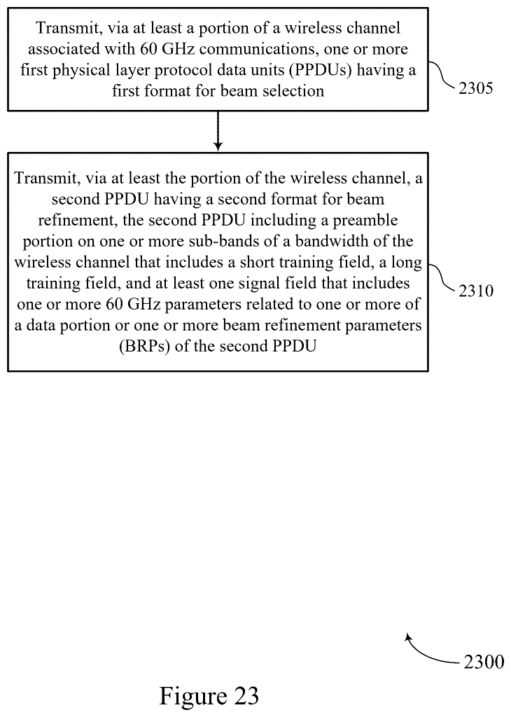

FIG. 23 shows a flowchart illustrating an example process 2300 performable by or at a wireless device that supports physical layer protocol data unit formats for 60 GHz communications. The operations of the process 2300 may be implemented by a wireless device or its components as described herein. For example, the process 2300 may be performed by a wireless communication device, such as the wireless communication device 1700 described with reference to FIG. 17, operating as or within a wireless AP or a wireless STA. In some examples, the process 2300 may be performed by a wireless AP or a wireless STA, such as one of the APs 102 or the STAs 104 described with reference to FIG. 1.

In some examples, in 2305, the wireless device may transmit, via at least a portion of a wireless channel associated with 60 GHz communications, one or more first PPDUs having a first format for beam selection. In some implementations, aspects of the operations of 2305 may be performed by a PPDU transmitter component 1745 as described with reference to FIG. 17.

In some examples, in 2310, the wireless device may transmit, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more BRPs of the second PPDU. In some implementations, aspects of the operations of 2310 may be performed by a PPDU transmitter component 1745 as described with reference to FIG. 17.

Implementation examples are described in the following numbered clauses:

Clause 1: A method for wireless communications at a wireless STA, comprising: receiving, via at least a portion of a wireless channel associated with 60 GHz communications, a PPDU including a preamble portion, a data portion, and one or more packet extension or training fields, the preamble portion including a short training field, a long training field, and at least one signal field that includes one or more 60 GHz parameters related to decoding of the data portion; and decoding the data portion in accordance with the one or more 60 GHz parameters.

Clause 2: The method of clause 1, wherein the PPDU has a frame structure that is upclocked from a PPDU frame structure associated with communications on one or more frequency bands that are lower than 60 GHz communications frequency bands.

Clause 3: The method of clause 2, wherein the preamble portion of the PPDU is upclocked at a smaller ratio than the data portion of the PPDU, and provides that one or more legacy fields of the preamble portion have a same tone spacing and symbol duration as the data portion.

Clause 4: The method of any of clauses 2 through 3, wherein the preamble portion of the PPDU spans multiple sub-bands of a bandwidth of the wireless channel, and the short training field, the long training field, and the at least one signal field are duplicated across multiple sub-bands, and the data portion spans all of the sub-bands of the bandwidth of the wireless channel.

Clause 5: The method of any of clauses 1 through 4, wherein at least the short training field, the long training field, and at least one signal field of the preamble portion are upclocked from corresponding fields of a PPDU frame structure associated with communications on one or more frequency bands that are lower than 60 GHz communications frequency bands, and the at least one signal field includes an integrated millimeter wave (IMMW) signal field that is associated with 60 GHz communications.

Clause 6: The method of clause 5, wherein the IMMW signal field includes legacy signal field information that is jointly encoded with one or more parameters associated with 60 GHz communications.

Clause 7: The method of any of clauses 5 through 6, wherein the IMMW signal field includes one or more version independent fields that are independent of a protocol version associated with the PPDU and one or more version dependent fields in accordance with the protocol version associated with the PPDU, and wherein the one or more version independent fields and the one or more version dependent fields are jointly encoded or are separately encoded.

Clause 8: The method of clause 7, wherein the at least one signal field includes a universal signal (U-SIG) field and the IMMW signal field.

Clause 9: The method of any of clauses 5 through 8, wherein a modulation scheme used to modulate the one or more signal fields of the preamble portion indicates a format or a variation associated with the PPDU, and the modulation scheme is selected from a binary phase-shift keying (BPSK) or a quadrature BPSK (QBPSK) modulation scheme.

Clause 10: The method of any of clauses 1 through 9, wherein the preamble portion includes a legacy short training field (L-STF) and a legacy long training field (L-LTF) that are duplicated in each sub-band of a plurality of sub-bands of a channel bandwidth of the wireless channel, and the one or more signal fields span all of the plurality of sub-bands.

Clause 11: The method of any of clauses 1 through 10, wherein the preamble portion includes a legacy short training field (L-STF) and a legacy long training field (L-LTF) that are duplicated in each sub-band of a plurality of sub-bands of a channel bandwidth of the wireless channel, and the one or more signal fields are duplicated in one or more smallest schedulable bandwidth blocks that each span two or more sub-bands of the plurality of sub-bands.

Clause 12: The method of any of clauses 1 through 11, wherein the preamble portion includes one or more legacy fields that are transmitted via a first portion of a channel bandwidth of the wireless channel, and one or more non-legacy fields of the preamble portion, and the data portion, are transmitted using a second portion of the channel bandwidth that is larger than the first portion of the channel bandwidth, where the first portion is a subset or a sub-band of the second portion.

Clause 13: The method of clause 12, wherein the one or more legacy fields are encoded in accordance with a 64 point fast Fourier transform, and have a same tone spacing as the data portion.

Clause 14: The method of any of clauses 12 through 13, wherein the first portion of a channel bandwidth corresponds to a smallest schedulable sub-band of the channel bandwidth irrespective of a size of the second portion of the channel bandwidth.

Clause 15: The method of any of clauses 1 through 14, wherein the preamble portion uses a same tone plan and a same numerology as the data portion.

Clause 16: The method of any of clauses 1 through 15, wherein the data portion includes control information that provides one or more of a ready to send (RTS) indication, a CTS indication, block acknowledgment (BA) information, or acknowledgment (ACK) information associated with wireless communications between the STA and an access point.

Clause 17: The method of clause 16, wherein the control information is transmitted in a medium access control (MAC) control frame included in the data portion using a smallest schedulable channel bandwidth of the wireless channel, and the PPDU is transmitted with increased power relative to a transmission that spans all sub-bands of a plurality of sub-bands of a bandwidth of the wireless channel.

Clause 18: The method of any of clauses 16 through 17, wherein the control information is transmitted in a medium access control (MAC) control frame included in the data portion using, and the PPDU is encoded over a smallest schedulable bandwidth and duplicated on two or more smallest bandwidth blocks that forma channel bandwidth of the wireless channel.

Clause 19: The method of any of clauses 1 through 18, wherein the PPDU is an enhanced long range (ELR) PPDU and includes one or more extension fields subsequent to the data portion, and the PPDU is transmitted in accordance with one or more of power boosting, a lower coding rate, a lower modulation order, or signal repetition, relative to a non-ELR PPDU.

Clause 20: A method for wireless communications at a wireless AP, comprising: encoding a data portion of a PPDU in accordance with one or more 60 GHz parameters associated with 60 GHz communications; and transmitting, via at least a portion of a wireless channel associated with 60 GHz communications, the PPDU to at least one STA, the PPDU including a preamble portion, the data portion, and one or more packet extension or training fields, the preamble portion including a short training field, a long training field, and at least one signal field that indicates the one or more 60 GHz parameters for decoding of the data portion.

Clause 21: The method of clause 20, wherein the PPDU has a frame structure that is upclocked from a PPDU frame structure associated with communications on one or more frequency bands that are lower than 60 GHz communications frequency bands.

Clause 22: The method of clause 21, wherein the preamble portion of the PPDU is upclocked at a smaller ratio than the data portion of the PPDU, and provides that one or more legacy fields of the preamble portion have a same tone spacing and symbol duration as the data portion.

Clause 23: The method of any of clauses 21 through 22, wherein the preamble portion of the PPDU spans multiple sub-bands of a bandwidth of the wireless channel, and the short training field, the long training field, and the at least one signal field are duplicated across multiple sub-bands, and the data portion spans all of the sub-bands of the bandwidth of the wireless channel.

Clause 24: The method of any of clauses 20 through 23, wherein at least the short training field, the long training field, and at least one signal field of the preamble portion are upclocked from corresponding fields of a PPDU frame structure associated with communications on one or more frequency bands that are lower than 60 GHz communications frequency bands, and the at least one signal field includes an integrated millimeter wave (IMMW) signal field that is associated with 60 GHz communications.

Clause 25: The method of clause 24, wherein the IMMW signal field includes legacy signal field information that is jointly encoded with one or more parameters associated with 60 GHz communications.

Clause 26: The method of any of clauses 24 through 25, wherein the IMMW signal field includes one or more version independent fields that are independent of a protocol version associated with the PPDU and one or more version dependent fields in accordance with the protocol version associated with the PPDU, and wherein the one or more version independent fields and the one or more version dependent fields are jointly encoded or are separately encoded.

Clause 27: The method of clause 26, wherein the at least one signal field includes a universal signal (U-SIG) field and the IMMW signal field.

Clause 28: The method of any of clauses 24 through 27, wherein a modulation scheme used to modulate the one or more signal fields of the preamble portion indicates a format or a variation associated with the PPDU, and the modulation scheme is selected from a binary phase-shift keying (BPSK) or a quadrature BPSK (QBPSK) modulation scheme.

Clause 29: The method of any of clauses 20 through 28, wherein the preamble portion includes a legacy short training field (L-STF) and a legacy long training field (L-LTF) that are duplicated in each sub-band of a plurality of sub-bands of a channel bandwidth of the wireless channel, and the one or more signal fields span all of the plurality of sub-bands.

Clause 30: The method of any of clauses 20 through 29, wherein the preamble portion includes a legacy short training field (L-STF) and a legacy long training field (L-LTF) that are duplicated in each sub-band of a plurality of sub-bands of a channel bandwidth of the wireless channel, and the one or more signal fields are duplicated in one or more smallest schedulable bandwidth blocks that each span two or more sub-bands of the plurality of sub-bands.

Clause 31: The method of any of clauses 20 through 30, wherein the preamble portion includes one or more legacy fields that are transmitted via a first portion of a channel bandwidth of the wireless channel, and one or more non-legacy fields of the preamble portion, and the data portion, are transmitted using a second portion of the channel bandwidth that is larger than the first portion of the channel bandwidth, where the first portion is a subset or a sub-band of the second portion.

Clause 32: The method of clause 31, wherein the one or more legacy fields are encoded in accordance with a 64 point fast Fourier transform, and have a same tone spacing as the data portion.

Clause 33: The method of any of clauses 31 through 32, wherein the first portion of a channel bandwidth corresponds to a smallest schedulable sub-band of the channel bandwidth irrespective of a size of the second portion of the channel bandwidth.

Clause 34: The method of any of clauses 20 through 33, wherein the preamble portion uses a same tone plan and a same numerology as the data portion.

Clause 35: The method of any of clauses 20 through 34, wherein the data portion includes control information that provides one or more of a ready to send (RTS) indication, a CTS indication, block acknowledgment (BA) information, or acknowledgment (ACK) information associated with wireless communications between the STA and an access point.

Clause 36: The method of clause 35, wherein the control information is transmitted in a medium access control (MAC) control frame included in the data portion using a smallest schedulable channel bandwidth of the wireless channel, and the PPDU is transmitted with increased power relative to a transmission that spans all sub-bands of a plurality of sub-bands of the channel bandwidth.

Clause 37: The method of any of clauses 35 through 36, wherein the control information is transmitted in a medium access control (MAC) control frame included in the data portion using, and the PPDU is encoded over a smallest schedulable bandwidth and duplicated on two or more smallest bandwidth blocks that forma channel bandwidth of the wireless channel.

Clause 38: The method of any of clauses 20 through 37, wherein the PPDU is an enhanced long range (ELR) PPDU and includes one or more extension fields subsequent to the data portion, and the PPDU is transmitted in accordance with one or more of power boosting, a lower coding rate, a lower modulation order, or signal repetition, relative to a non-ELR PPDU.

Clause 39: A wireless STA for wireless communications, comprising a processing system that includes processor circuitry and memory circuitry that stores code, the processing system configured to cause the wireless STA to perform a method of any of clauses 1 through 19.

Clause 40: A wireless STA for wireless communications, comprising at least one means for performing a method of any of clauses 1 through 19.

Clause 41: A non-transitory computer-readable medium storing code for wireless communications, the code comprising instructions executable by one or more processors to perform a method of any of clauses 1 through 19.

Clause 42: A wireless AP for wireless communications, comprising a processing system that includes processor circuitry and memory circuitry that stores code, the processing system configured to cause the wireless AP to perform a method of any of clauses 20 through 38.

Clause 43: A wireless AP for wireless communications, comprising at least one means for performing a method of any of clauses 20 through 38.

Clause 44: A non-transitory computer-readable medium storing code for wireless communications, the code comprising instructions executable by one or more processors to perform a method of any of clauses 20 through 38.

Clause 45: A method for wireless communications at a wireless device, comprising: receiving, via at least a portion of a wireless channel associated with 60 GHz communications, a PPDU including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion; and decoding the data portion in accordance with the one or more 60 GHz parameters.

Clause 46: The method of clause 45, wherein the legacy preamble portion spans all sub-bands of the bandwidth of the wireless channel.

Clause 47: The method of any of clauses 45 through 46, wherein a first instance of the legacy preamble portion spans a first subset of sub-bands of the bandwidth of the wireless channel, and a second duplicated instance of the legacy preamble portion spans a second subset of sub-bands of the bandwidth of the wireless channel.

Clause 48: The method of any of clauses 45 through 47, wherein the legacy preamble portion spans a subset of sub-bands of the bandwidth of the wireless channel, and is transmitted with increased power relative to the non-legacy preamble portion that spans all of the sub-bands of the bandwidth of the wireless channel.

Clause 49: The method of any of clauses 45 through 48, wherein two or more instances of the legacy preamble portion are duplicated in time on the one or more sub-bands of the bandwidth of the wireless channel.

Clause 50: The method of clause 49, wherein the legacy preamble portion includes a short training field, a long training field, and at least one signal field that are each duplicated in time on the one or more sub-bands of the bandwidth of the wireless channel.

Clause 51: The method of any of clauses 45 through 50, wherein the one or more sub-bands include sub-bands each have a bandwidth associated with a base bandwidth mode or smallest bandwidth allowed in an integrated millimeter wave (IMMW) 60 GHz communications system.

Clause 52: The method of any of clauses 45 through 51, wherein the at least one signal field includes an integrated millimeter wave (IMMW) signal field that is associated with 60 GHz communications.

Clause 53: The method of clause 52, wherein the IMMW signal field includes a common portion, and one or more of a data demodulation portion, a beam refinement parameter (BRP) portion, or a sector sweep (SSW) portion.

Clause 54: The method of clause 53, wherein the common portion of the IMMW signal field is separately encoded from other portions of the IMMW signal field.

Clause 55: The method of any of clauses 53 through 54, wherein the common portion of the IMMW signal field includes an indication of a PPDU type of the PPDU, and wherein the PPDU type indicates which of the data demodulation portion, the BRP portion, or the SSW portion are included in the IMMW signal field.

Clause 56: A method for wireless communications at a wireless device, comprising: receiving, via at least a portion of a wireless channel associated with 60 GHz communications, one or more first physical layer protocol data units (PPDUs) having a first format for beam selection; selecting a first beam for communications based at least in part on the one or more first PPDUs; and receiving, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more beam refinement parameters (BRPs) of the second PPDU.

Clause 57: The method of clause 56, wherein the one or more first PPDUs are sector sweep (SSW) PPDUs that are transmitted using different beams, and wherein the SSW PPDUs are null data packet (NDP) PPDUs.

Clause 58: The method of any of clauses 56 through 57, wherein the second PPDU is a BRP PPDU that is transmitted with or without an associated data portion.

Clause 59: The method of clause 58, wherein the BRP PPDU includes a flexible length long training field that includes one or more signals for refinement of receive beamforming parameters.

Clause 60: The method of any of clause 56 through 59, wherein the one or more first PPDUs are sector sweep (SSW) PPDUs that include only a legacy preamble portion that includes a short training field (STF), a long training field (LTF), and a signal (SIG) field.

Clause 61: A method for wireless communications at a wireless device, comprising: encoding a data portion of a PPDU in accordance with one or more 60 GHz parameters associated with 60 GHz communications; and transmitting, via at least a portion of a wireless channel associated with 60 GHz communications, the PPDU to at least one other wireless device, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion.

Clause 62: The method of clause 61, wherein the legacy preamble portion spans all sub-bands of the bandwidth of the wireless channel.

Clause 63: The method of any of clauses 61 through 62, wherein a first instance of the legacy preamble portion spans a first subset of sub-bands of the bandwidth of the wireless channel, and a second duplicated instance of the legacy preamble portion spans a second subset of sub-bands of the bandwidth of the wireless channel.

Clause 64: The method of any of clauses 61 through 63, wherein the legacy preamble portion spans a subset of sub-bands of the bandwidth of the wireless channel, and is transmitted with increased power relative to the non-legacy preamble portion that spans all of the sub-bands of the bandwidth of the wireless channel.

Clause 65: The method of any of clauses 61 through 64, wherein two or more instances of the legacy preamble portion are duplicated in time on the one or more sub-bands of the bandwidth of the wireless channel.

Clause 66: The method of clause 65, wherein the legacy preamble portion includes a short training field, a long training field, and at least one signal field that are each duplicated in time on the one or more sub-bands of the bandwidth of the wireless channel.

Clause 67: The method of any of clauses 65 through 66, wherein the one or more sub-bands include sub-bands each have a bandwidth associated with a base bandwidth mode or smallest bandwidth allowed in an integrated millimeter wave (IMMW) 60 GHz communications system.

Clause 68: The method of any of clauses 61 through 67, wherein the at least one signal field includes an integrated millimeter wave (IMMW) signal field that is associated with 60 GHz communications.

Clause 69: The method of clause 68, wherein the IMMW signal field includes a common portion, and one or more of a data demodulation portion, a beam refinement parameter (BRP) portion, or a sector sweep (SSW) portion.

Clause 70: The method of clause 69, wherein the common portion of the IMMW signal field is separately encoded from other portions of the IMMW signal field.

Clause 71: The method of any of clauses 69 through 70, wherein the common portion of the IMMW signal field includes an indication of a PPDU type of the PPDU, and wherein the PPDU type indicates which of the data demodulation portion, the BRP portion, or the SSW portion are included in the IMMW signal field.

Clause 72: A method for wireless communications at a wireless device, comprising: transmitting, via at least a portion of a wireless channel associated with 60 GHz communications, one or more first physical layer protocol data units (PPDUs) having a first format for beam selection; and transmitting, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more beam refinement parameters (BRPs) of the second PPDU.

Clause 73: The method of clause 72, wherein the one or more first PPDUs are sector sweep (SSW) PPDUs that are transmitted using different beams, and wherein the SSW PPDUs are null data packet (NDP) PPDUs.

Clause 74: The method of any of clauses 72 through 73, wherein the second PPDU is a BRP PPDU that is transmitted with or without an associated data portion.

Clause 75: The method of clause 74, wherein the BRP PPDU includes a flexible length long training field that includes one or more signals for refinement of receive beamforming parameters.

Clause 76: The method of any of clauses 72 through 75, wherein the one or more first PPDUs are sector sweep (SSW) PPDUs that include only a legacy preamble portion that includes a short training field (STF), a long training field (LTF), and a signal (SIG) field.

Clause 77: A wireless device for wireless communications, comprising a processing system that includes processor circuitry and memory circuitry that stores code, the processing system configured to cause the wireless device to perform a method of any of clauses 45 through 55.

Clause 78: A wireless device for wireless communications, comprising at least one means for performing a method of any of clauses 45 through 55.

Clause 79: A non-transitory computer-readable medium storing code for wireless communications, the code comprising instructions executable by one or more processors to perform a method of any of clauses 45 through 55.

Clause 80: A wireless device for wireless communications, comprising a processing system that includes processor circuitry and memory circuitry that stores code, the processing system configured to cause the wireless device to perform a method of any of clauses 56 through 60.

Clause 81: A wireless device for wireless communications, comprising at least one means for performing a method of any of clauses 56 through 60.

Clause 82: A non-transitory computer-readable medium storing code for wireless communications, the code comprising instructions executable by one or more processors to perform a method of any of clauses 56 through 60.

Clause 83: A wireless device for wireless communications, comprising a processing system that includes processor circuitry and memory circuitry that stores code, the processing system configured to cause the wireless device to perform a method of any of clauses 61 through 71.

Clause 84: A wireless device for wireless communications, comprising at least one means for performing a method of any of clauses 61 through 71.

Clause 85: A non-transitory computer-readable medium storing code for wireless communications, the code comprising instructions executable by one or more processors to perform a method of any of clauses 61 through 71.

Clause 86: A wireless device for wireless communications, comprising a processing system that includes processor circuitry and memory circuitry that stores code, the processing system configured to cause the wireless device to perform a method of any of clauses 72 through 76.

Clause 87: A wireless device for wireless communications, comprising at least one means for performing a method of any of clauses 72 through 76.

Clause 88: A non-transitory computer-readable medium storing code for wireless communications, the code comprising instructions executable by one or more processors to perform a method of any of clauses 72 through 76.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
a processing system that includes processor circuitry and memory circuitry that stores code, the processing system configured to cause the wireless device to:
receive, via at least a portion of a wireless channel associated with 60 GHz communications, a physical layer protocol data unit (PPDU) including a legacy preamble portion on one or more sub-bands of a bandwidth of the wireless channel, a non-legacy preamble portion that spans the bandwidth of the wireless channel, and one or more of a data portion or packet extension or training field portion, the legacy preamble portion including a short training field, a long training field, and at least one signal field that includes one or more 60 GHz parameters related to decoding of the data portion; and
decode the data portion in accordance with the one or more 60 GHz parameters.

2. The wireless device of claim 1, wherein:
the legacy preamble portion spans all sub-bands of the bandwidth of the wireless channel.

3. The wireless device of claim 1, wherein:
a first instance of the legacy preamble portion spans a first subset of sub-bands of the bandwidth of the wireless channel, and a second duplicated instance of the legacy preamble portion spans a second subset of sub-bands of the bandwidth of the wireless channel.

4. The wireless device of claim 1, wherein:
the legacy preamble portion spans a subset of sub-bands of the bandwidth of the wireless channel, and is transmitted with increased power relative to the non-legacy preamble portion that spans all of the sub-bands of the bandwidth of the wireless channel.

5. The wireless device of claim 1, wherein:
two or more instances of the legacy preamble portion are duplicated in time on the one or more sub-bands of the bandwidth of the wireless channel.

6. The wireless device of claim 5, wherein:
the legacy preamble portion includes a short training field, a long training field, and at least one signal field that are each duplicated in time on the one or more sub-bands of the bandwidth of the wireless channel.

7. The wireless device of claim 1, wherein:
the one or more sub-bands include sub-bands each have a bandwidth associated with a base bandwidth mode or smallest bandwidth allowed in an integrated millimeter wave (IMMW) 60 GHz communications system.

8. The wireless device of claim 1, wherein:
the at least one signal field includes an integrated millimeter wave (IMMW) signal field that is associated with 60 GHz communications.

9. The wireless device of claim 8, wherein:
the IMMW signal field includes a common portion, and one or more of a data demodulation portion, a beam refinement parameter (BRP) portion, or a sector sweep (SSW) portion.

10. The wireless device of claim 9, wherein:
the common portion of the IMMW signal field is separately encoded from other portions of the IMMW signal field.

11. The wireless device of claim 9, wherein:
the common portion of the IMMW signal field includes an indication of a PPDU type of the PPDU, and wherein the PPDU type indicates which of the data demodulation portion, the BRP portion, or the SSW portion are included in the IMMW signal field.

12. A wireless device, comprising:
a processing system that includes processor circuitry and memory circuitry that stores code, the processing system configured to cause the wireless device to:
receive, via at least a portion of a wireless channel associated with 60 GHz communications, one or more first physical layer protocol data units (PPDUs) having a first format for beam selection;
select a first beam for communications based at least in part on the one or more first PPDUs; and
receive, via at least the portion of the wireless channel, a second PPDU having a second format for beam refinement, the second PPDU including a preamble portion on one or more sub-bands of a bandwidth of the wireless channel that includes a short training field, a long training field, and at least one signal field that includes one or more 60 GHz parameters related to one or more of a data portion or one or more beam refinement parameters (BRPs) of the second PPDU.

13. The wireless device of claim 12, wherein:
the one or more first PPDUs are sector sweep (SSW) PPDUs that are transmitted using different beams, and wherein the SSW PPDUs are null data packet (NDP) PPDUs.

14. The wireless device of claim 12, wherein:
the second PPDU is a BRP PPDU that is transmitted with or without an associated data portion.

15. The wireless device of claim 14, wherein:
the BRP PPDU includes a flexible length long training field that includes one or more signals for refinement of receive beamforming parameters.

16. The wireless device of claim 12, wherein:
the one or more first PPDUs are sector sweep (SSW) PPDUs that include only a legacy preamble portion that includes a short training field (STF), a long training field (LTF), and a signal (SIG) field.

17. A wireless device, comprising:
a processing system that includes processor circuitry and memory circuitry that stores code, the processing system configured to cause the wireless device to:
encode a data portion of a physical layer protocol data unit (PPDU) in accordance with one or more 60 GHz parameters associated with 60 GHz communications; and
transmit, via at least a portion of a wireless channel associated with 60 GHz communications, the PPDU to at least one other wireless device, the PPDU including a legacy preamble portion on one or more sub-bands of a bandwidth of the wireless channel, a non-legacy preamble portion that spans the bandwidth of the wireless channel, and one or more of a data portion, a packet extension, or a training field portion, the legacy preamble portion including a short training field, a long training field, and at least one signal field that includes one or more 60 GHz parameters related to decoding of the data portion.

18. The wireless device of claim 17, wherein:
two or more instances of the legacy preamble portion are duplicated in time on the one or more sub-bands of the bandwidth of the wireless channel.

19. The wireless device of claim 17, wherein:
the at least one signal field includes an integrated millimeter wave (IMMW) signal field that is associated with 60 GHz communications, and wherein the IMMW signal field includes a common portion, and one or more of a data demodulation portion, a beam refinement parameter (BRP) portion, or a sector sweep (SSW) portion.

20. The wireless device of claim 19, wherein:
the common portion of the IMMW signal field is separately encoded from other portions of the IMMW signal field.
